(19) United States
(12) Patent Application Publication
(10) Pub. No.: US 2006/0289526 A1
(43) Pub. Date: Dec. 28, 2006

(54) High-frequency heating device and method for controlling same

(75) Inventors: Takeshi Takizaki, Souraku-gun (JP); Tomotaka Nobue, Yamatokoriyama-shi (JP); Kazuho Sakamoto, Souraku-gun (JP); Makoto Mihara, Nara-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 10/553,511

(22) PCT Filed: Apr. 23, 2004
(86) PCT No.: PCT/JP04/05889

§ 371 Date: Jun. 23, 2006

(30) Foreign Application Priority Data
Apr. 25, 2003 (JP) 2003-121876
May 8, 2003 (JP) 2003-130370
May 9, 2003 (JP) 2003-131804

(51) Int. Cl. H05B 6/74

(52) U.S. Cl. 219/746

(57) ABSTRACT

A problem of the invention is to provide a high frequency heating apparatus capable of realizing excellent heating without an irregularity in heating even for a thick-walled heated object.

In order to resolve the above-described problem, according to a high frequency heating apparatus of the invention, a high frequency heating apparatus 1 for heating a heated object by irradiating a microwave having a frequency of 5.8 GHz to the heated object is constituted by mounting a plurality of pieces of wave guides 11a, 11b having feeding ports 7, 9 for emitting microwaves into a cavity 3 partitioning a heating chamber 2.

### TECHNICAL FIELD

The present invention relates to a high frequency heating apparatus for heating an object to be heated by supplying a high frequency wave to a heating chamber containing the object and its control method.

### BACKGROUND ART

A high frequency apparatus having high frequency generating means (magnetron) for outputting a microwave into a heating chamber accommodating an object to be heated has rapidly been spread as a microwave oven which is a heating cooking apparatus of a foodstuff or the like since the object in the heating chamber can be heated in a short period of time and efficiently.

Meanwhile, according to the microwave oscillated into the heating chamber, when there is not electromagnetic wave stirring means in the heating chamber, a standing wave is formed by reflection at an inner wall face of a cavity partitioning the heating chamber and heating spots are produced at intervals of about a half of a wavelength of the standing wave.

In the case of a house use microwave oven of a background art, the microwave oven is mounted with a magnetron for oscillating a microwave having a frequency of 2.45 GHz and in this case, a wavelength of a generated standing wave becomes about 12 centimeters, heating spots are produced at intervals of about 6 centimeters of a half thereof, in comparison with a size of a food stuff heated in a general household or the like, the interval of the heating spots is large to cause an irregularity in heating.

Hence, the microwave oven of the background art is equipped with a turn table for rotating the food product in the heating chamber or electromagnetic wave stirring means of a stirrer fan for stirring the electromagnetic wave in the heating chamber or the like in order to reduce an influence of the standing wave causing the irregularity in heating.

However, the equipments make a movable part penetrated through a wall portion of the cavity partitioning the heating chamber indispensable, a structure of attaching the movable part onto the cavity for preventing leakage of the electromagnetic wave at the cavity penetrating portion by the movable part is complicated to bring about an increase in cost of fabrication cost by an increase in constituent parts or large-sized formation of the apparatus.

Hence, recently, there have been carried out researches on prevention of an irregularity in heating on a heated object from being brought about by contracting an interval of heated spots constituting a half of a wavelength of a standing wave by changing a frequency of a microwave used without being equipped with a turn table or electromagnetic stirring means of a stirrer fan or the like and a microwave of 5.8 GHz has been proposed to use (refer to, for example, Patent Reference 1).

(Patent Reference 1)

JP-A-3-203191

According to an microwave oven using a microwave of 5.8 GHz, when a standing wave is formed by reflection of the microwave by an inner wall face of a cavity, a wavelength of the standing wave becomes about 5 cm, an interval of heating spots in a heating chamber becomes 2.5 cm of a half of the wavelength, in comparison with an microwave oven using a microwave of 2.45 GHz, a density of distributing the heating spots on a surface of a heated object is increased, the interval of the heating spots is not excessively larger than a size of a general food stuff and therefore, an irregularity in heating can be restrained from being brought out without being equipped with the electromagnetic wave stirring means of the background art, and by deleting the electromagnetic stirring means, simplification of the structure, small-sized formation of the apparatus in accordance with the simplification, or a reduction in fabrication cost or running cost can be achieved.

On the other hand, according to the microwave of 5.8 GHz, when compared with the microwave of 2.45 GHz, a heating depth to an inner portion of the heated object becomes shallow and therefore, as shown by FIG. 9, although a heating distribution characteristic at a surface of the heated object is more excellent than that of the microwave of 2.45 GHz, a heating characteristic thereof to an inner portion of the heated object becomes inferior to that of the microwave of 2.45 GHz.

As a result, according to a constitution of oscillating the microwave from a single feeding port into the heating chamber as in the microwave oven of the background art disclosed in Patent Reference 1, mentioned above, when a thickness of the heated object constituting an object of heating is thick, although a surface layer on a side on which the microwave is easy to impinge can sufficiently be heated, with regard to a surface layer on other side and an inner portion of the heated object, there is a concern of bringing about an irregularity in heating or a deficiency in heating.

It is an object of the invention to provide a high frequency heating apparatus capable of irradiating a microwave to a surface of a heated object in a wider range, capable of realizing to heat even a thick-walled heated object excellently without an irregularity in heating, further, capable of achieving simplification of a structure, small-sized formation of an apparatus in accordance therewith, or a reduction in fabrication cost or running cost by enabling to omit electromagnetic wave stirring means.

Further, according to a high frequency heating apparatus of a background art, a high frequency generating portion of a magnetron is provided on an outer side of a heating chamber, a high frequency wave is guided by passing the high frequency wave through a wave guide therefrom to a large single piece feeding port provided at any of a ceiling, a side wall, a floor portion of the heating chamber and the high frequency wave is guided into the heating chamber from the feeding port (refer to, for example, Patent Reference 2).

(Patent Reference 2)

JP-A-3-203191

FIG. 14 is a vertical sectional view showing an inner structure of the high frequency heating apparatus of the background art described in Patent Reference 2. In the drawing, numeral 150 designates the high frequency heating apparatus of the background art, numeral 151 designates the heating chamber, numeral 152 designates the high frequency generating portion provided on the outer side of the heating chamber 151 and including the magnetron for oscillating a microwave of a frequency of 2.45 GHz, numeral 153 designates the wave guide, and numeral 154 designates the feeding port. Numeral 155 designates a turn table, numeral 156 designates a motor for driving to rotate the turn table 155, numeral 157 designates a door, and numeral 158 designates radio wave leakage preventing means having a choke structure in correspondence with a quarter wavelength of the microwave provided to four corners of the door 157. Notation G designates the heated object mounted on the turntable 155.

When the magnetron 152 is driven, the microwave having the frequency of 2.45 GHz oscillated from the magnetron 152 is irradiated from the feeding port 154 into the heating chamber 151 by passing the wave guide 153, and reflected by a metal wall of the heating chamber 151 to generate a standing wave at inside of the heating chamber 151. In the case of the microwave having the frequency of 2.45 GHz, the wavelength becomes about 12 cm and therefore, an interval of the standing wave generated in the heating chamber 151 produced by reflecting the microwave by the metal wall of the heating chamber 151 becomes about 6 cm of a half thereof and the microwave is absorbed by the heated object G to heat the heated object G at a portion of an antinode thereof having a strong electric field.

However, the interval of about 6 cm constitutes an irregularity for the heated object G and therefore, an electric field on the heated object G is disturbed by slowly rotating the turntable 155 by the motor 56 to prevent the standing wave from being generated on the heated object G.

In this way, according to the high frequency heating apparatus 150 of the background art, in order to carry out heating without irregularity, the turn table 155 and the motor 156 are needed and therefore, the structure is complicated, reliability is deteriorated and cost is increased.

As a constitution of resolving the drawback, there is the high frequency heating apparatus of the embodiment described in Patent Reference 2. FIG. 15 illustrates views showing an inner structure of the high frequency heating apparatus of the embodiment described in Patent Reference 2, FIG. 15(a) is a vertical sectional view, and FIG. 15(b) is a cross-sectional view passing a wave guide 53 of FIG. 15(a).

In FIG. 15(a), numeral 160 designates the high frequency heating apparatus of the embodiment, numeral 161 designates a heating chamber, numeral 162 designates a high frequency generating portion provided on an outer side of the heating chamber 161 and including a magnetron for oscillating a microwave having a frequency of 5.8 GHz, numeral 163 designates a wave guide, numeral 164 designates a feeding port. Numeral 165 designates a table for mounting a heated object, numeral 167 designates a door, and numeral 168 designates radio wave leakage preventing means of a choke structure provided at four corners of the door 167 in correspondence with a quarter wavelength of the microwave. Notation G designates a heated object mounted on the table 165.

Further, in FIG. 15(b), a single piece of the feeding port 164 is provided at a front end of the narrow wave guide 153 having a width substantially equal to a lateral width of the high frequency generating portion 162, and the microwave oscillated from the high frequency generating portion 162 is irradiated into the heating chamber 161 only from the feeding port 164.

Hence, when the magnetron 162 is driven, the microwave having the frequency of 5.8 GHz oscillated from the magnetron 162 is irradiated into the heating chamber 161 from the feeding port 164 by passing the wave guide 163 and is reflected by a metal wall of the heating chamber 161 to generate a standing wave at inside of the heating chamber 161. In the case of the microwave having the frequency of 5.8 GHZ, the wavelength becomes about 5.17 cm and therefore, the interval of the standing wave generated in the heating chamber 161 by reflecting the microwave by the metal wall of the heating chamber 161 becomes about 2.6 cm of a half thereof, the microwave is absorbed by the heated object G at a portion of an antinode having a strong electric field to heat the heated object G Further, the interval of about 2.6 cm is small for the heated object G and therefore, a conspicuous irregularity is not constituted.

Therefore, the turn table and the motor serving as described above are not needed and therefore, the structure becomes simple, the reliability is promoted and the cost becomes inexpensive.

Although the irregularity in heating becomes inconspicuous since the interval of the standing wave generated in the heating chamber 161 becomes about 2.6 cm of a half thereof because the high frequency heating apparatus 160 of FIG. 15 uses the magnetron for oscillating the microwave having the frequency of 5.8 GHZ in this way, more or less irregularity is still produced.

Further, the feeding port 164 is provided only at a center of a ceiling of the heating chamber 161 and therefore, there is brought about a difference in an electric field intensity of the microwave between a center and a corner of the heating chamber 161 and therefore, there is brought about a difference in heating between a center and an end of the heated object G.

It is an object of the invention to resolve the drawback to provide a high frequency heating apparatus capable of making an irregularity in heating further inconspicuous and capable of effectively utilizing a space at a vicinity of a center portion on a rear side of a floor portion of the heating chamber without producing a difference in an electric field intensity of a microwave between a center and a corner of the heating chamber.

Heretofore, there has widely been utilized a high frequency heating apparatus for heating and cooking a heated object by supplying a high frequency wave to a heating chamber containing a heated object for heating and cooking a food stuff. The high frequency heating apparatus of this kind is mounted with a magnetron for generating a high frequency wave having a frequency of 2.45 GHz for supplying the generated high frequency wave into the heating chamber. A standing wave is formed in the heating chamber by supplying the high frequency wave, a wavelength of the generated standing wave becomes about 12 cm, and substantially heating spots having a strong electric field are produced at an interval of about 6 cm of a half thereof. However, the interval of the heating spots is longer than a size of a food stuff to be heated and cooked and therefore, a density of distributing the heating spots which can be present in the food stuff becomes low, the food stuff is partially heated and an irregularity in heating tends to be liable to be produced.

Hence, there is proposed a technology for reducing the irregularity in heating the heated object by narrowing the interval of the heating spots by changing the frequency of the high frequency used from 2.45 GHz to 5.8 GHz to thereby increase the density of distributing the heating spots (refer to, for example, Patent Reference 3).

(Patent Reference 3)

JP-A-3-203191

However, whereas according to the high frequency of 5.8 GHz, the density of distributing the heating spots becomes higher than that of the high frequency of 2.45 GHz, a depth thereof of being absorbed to the heated object becomes shallow and therefore, when the heated object is thick-walled, an irregularity in heating in which a surface of the heated object is mainly heated and an inner portion of the heated object is deficient in heating is liable to be brought about.

Therefore, in the case of the high frequency of 5.8 GHz the heating distribution of which becomes dense, although when the heated object is thin-walled, an excellent uniform heating effect can be expected, with regard to the thick-walled heated object, the irregularity in heating is increased in the depth direction, as a result, uniform heating becomes difficult. Further, although in the case of a thick wall, the inner portion is heated from the surface of the heated object by heat conduction, time is taken until conducting heat to the inner portion and a rapid heating effect which is the best advantage of high frequency heating is not achieved.

The invention has been carried out in consideration of the above-described situation and it is an object thereof to provide a high frequency heating apparatus capable of carrying out a uniform heating processing swiftly even in the case of a thick-walled heated object by restraining an irregularity in heating from being brought about.

### DISCLOSURE OF THE INVENTION

A high frequency heating apparatus according to the invention for achieving the above-described object is characterized in a high frequency heating apparatus for heating a heated object by irradiating a microwave of 5.8 GHz to the heated object in a heating chamber, wherein a plurality of pieces of wave guides having feeding ports for emitting the microwave are mounted to a cavity partitioning the heating chamber.

According to the high frequency heating apparatus constituted in this way, a distribution of heating spots by the microwave is widened by a plurality of the feeding ports by a plurality of pieces of the wave guides and the microwave can be made to impinge on a portion of a wider range of a surface of the heated object.

As a result, even in the case of a microwave of 5.8 GHz having a shallow baking depth, a substantial baking depth can be intensified to double by heating the heated object from, for example, two directions opposed to each other.

Further, in order to compensate for a drawback that a baking depth of the microwave of 5.8 GHz is shallow, from a view point of increasing faces on the heated object on which the microwave is made to impinge, it is preferable to mount the feeding ports for emitting the microwaves dispersingly at a plurality of wall faces of the cavity, specifically, as described in Claim 2, there may be constructed a constitution in which that a wall face of the cavity arranged with the feeding port is constituted by upper and lower faces, or the upper face and a side face, or the side face and the lower face of the heating chamber.

Further, from a view point of uniformly dispersing irradiation of the microwave from the upper face to the heated object in the heating chamber in a wide range, as described in Claim 3, there may be constructed a constitution in which two pieces of the feeding ports are provided to the upper face of the heating chamber by at least two pieces of the wave guides arranged at an upper wall of the cavity.

Further, the high frequency heating apparatus described in Claim 4 is characterized in that the at least two pieces of wave guides at the upper wall of the cavity are arranged vertically to direct long sides of cross-sectional faces of the wave guides in an up and down direction in the high frequency heating apparatus described in Claim 3.

A cross-sectional area of a wave guide for guiding a microwave of 5.8 GHz is contracted to about ¼ of a cross-sectional area of a wave guide for guiding a microwave of 2.45 GHz. Therefore, a long side dimension of the wave guide for 5.8 GHz is to a degree substantially the same as a short side dimension of the wave guide for 2.45 GHz.

Therefore, even when a space of installing a wave guide ensured on a side of the upper face of the cavity is set to be equivalent to that of the high frequency heating apparatus of the background art in which the wave guide for 2.45 G-Hz is installed at the upper face of the cavity by directing the long side horizontally, the wave guide for 5.8 GHz can be mounted to be arranged vertically to direct the long side vertically. Further, by constructing a constitution of mounting to arrange the wave guide vertically in this way, an area occupied by the wave at the upper face of the cavity can be contracted.

As a result, a vacant space is increased at the upper face of the cavity and when there is constructed a constitution in which a face heater is arranged at a region of the upper wall of the cavity excluding a region of mounting the wave guides arranged vertically as described in Claim 5, a region of mounting the face heater can be enlarged, a temperature distribution in an oven heating processing operating the face heater can be made to be uniform in a wider region and oven heating without an irregularity in heating can be realized.

Further, a high frequency heating apparatus of the invention is characterized in a high frequency heating apparatus including a high frequency generating portion, and a heating chamber constituted by a ceiling, a side wall and a floor portion for heating to process a heated object by applying a high frequency wave from the high frequency generating portion, wherein a wide range wave guide in a shape of a parallelepiped constituted by including a number of feeding ports is provided on a rear side of the heating chamber, and the high frequency generating portion is provided at immediate proximity of the wide range wave guide of the shape of the parallelepiped.

According to the above-described constitution, a structure of the wave guide is constituted by a structure having a wide width and therefore, a number of feeding ports can be provided and heating can be made to be proximate to uniform heating.

Further, the high frequency heating apparatus of the invention is characterized in that the wide range wave guide in the shape of the parallelepiped is constituted by a size widened substantially over an entire face of the floor portion and the number of feeding ports are provided on a rear side of the floor portion to direct to a side of the floor portion.

According to the above-described constitution, substantially a total of a rear side of the floor portion is constituted by a structure of the wave guide, substantially the total face of the floor portion is provided with the number of feeding ports and therefore, there is not brought about a difference in an electric field intensity of the microwave between a center and a corner of the heating chamber and heating can be made to be proximate to uniform heating. Further, owing to irradiation of the microwave from the floor portion, the irradiation is proximate to the heated portion and also a heating efficiency is improved.

Further, a constitution of a turntable, a rotational antenna or the like for stirring radio wave may not be provided and therefore, reliability against radio wave spark, radio wave leakage or the like is also promoted.

Further, the high frequency heating apparatus of the invention is characterized in that the wide range wave guide in the shape of the parallelepiped is constituted by a size widened substantially over an entire face of the ceiling and the number of feeding ports are provided on a rear side of the ceiling to direct to a side of the ceiling.

According to the above-described constitution, substantially the total of the rear side of the ceiling is constituted by the structure of the wave guide, a number of feeding ports are provided at substantially a total face and therefore, uniform radio wave falls from a single face of the ceiling as in a shower and therefore, further uniform heating can be carried out.

Further, the high frequency heating apparatus of the invention is characterized in that a frequency of the high frequency wave supplied from the high frequency generating portion is 5.8 GHz.

According to the above-described constitution, an interval of standing waves becomes narrower than that in the case in which the wave length of the microwave is 2.45 GHz constituting the main current of the background art and therefore, heating can be made to be proximate to further uniform heating.

Further, the high frequency heating apparatus of the invention is characterized in that sizes of the number of pieces of feeding ports are smaller at a vicinity of the high frequency generating portion and the remoter from the high frequency generating portion, the larger the sizes.

According to the above-described constitution, there is not brought about a difference in the electric field intensity of the microwave between a vicinity of the high frequency generating portion and a portion remote from the high frequency generating portion and heating can be made to be proximate to further uniform heating.

Further, the object of the invention is achieved by constitutions described below.

(1) A high frequency heating apparatus which is a high frequency heating apparatus for heating to process a heated object by supplying a high frequency wave from a high frequency generating portion to a heating chamber for containing the heated object, wherein the high frequency generating portion includes a first high frequency generating portion for generating the high frequency wave having a frequency of 2.45 GHz and a second high frequency generating portion for generating the high frequency wave having a frequency of 5.8 GHz.

According to the high frequency heating apparatus, two kinds of the high frequency waves of the high frequency wave having a frequency of 2.45 GHz having a high heating effect and the high frequency wave having a frequency of 5.8 GHz a heating distribution of which is uniform can be supplied to the heating chamber, an irregularity in heating is restrained from being brought about, and even the thick-walled heated object can be heated to process swiftly and uniformly.

(2) The high frequency heating apparatus described in (1), further including a first inverter circuit for supplying a drive power to the first high frequency generating portion, a second inverter circuit for supplying a drive power to the second high frequency generating portion, and a drive control portion for simultaneously or alternately driving the first high frequency generating portion and the second high frequency generating portion by the inverter circuits.

According to the high frequency heating apparatus, powers of driving the first high frequency generating portion and the second high frequency generating portion are supplied by respectively separate inverter circuits and therefore, the high frequency waves can be outputted from the respective high frequency generating portions simultaneously or alternately, further, also output intensities can be made variable and therefore, even a complicated heating pattern can simply be controlled.

(3) The high frequency heating apparatus described in (1), further including a single inverter circuit for supplying a drive power to the first high frequency generating portion and the second high frequency generating portion, and a drive control portion for alternately switching to feed electricity to drive the first high frequency generating portion and the second high frequency generating portion.

According to the high frequency heating apparatus, electricity can be controlled to feed to the first high frequency generating portion and the second high frequency generating portion by the single inverter circuit and therefore, a circuit constitution of the drive control portion is simplified, and a space needed for installing thereof is reduced, which can contribute to the small-sized and the light-weighted formation of the apparatus.

(4) The high frequency heating apparatus described in any one of (1) through (3), further including an upper side feeding port provided at an upper face of the heating chamber for introducing the high frequency wave into the heating chamber, and a lower side feeding port provided at a lower face of the heating chamber for introducing the high frequency wave into the heating chamber, wherein the high frequency wave from the first high frequency generating portion or the second high frequency generating portion is introduced individually from respectives of the upper side feeding port and the lower side feeding port.

According to the high frequency heating apparatus, the high frequency wave from the first high frequency generating portion or the second high frequency generating portion is introduced from respectives of the upper side feeding port and the lower side feeding port individually to the heating chamber and therefore, the respective high frequency waves can be irradiated from an optimum position in accordance with heating characteristics of the high frequency waves.

(5) The high frequency heating apparatus described in (4), further including a partition plate for dividing a space of the heating chamber upward and downward.

According to the high frequency heating apparatus, by diving a space of the heating chamber upward and downward, one of the high frequency waves can be supplied to an upper side space, other of the high frequency waves can be supplied to a lower side space, and the heated object can be heated by supplying the respective high frequency waves to the individual spaces.

(6) The high frequency heating apparatus described in (5), wherein the partition plate includes a high frequency heat generating member for generating heat by being irradiated with the high frequency wave.

According to the high frequency heating apparatus, the high frequency heat generating member of the partition plate generates heat by being irradiated with the high frequency wave and therefore, a cooking mark can be attached to the heated object by heating the heated object mounted on the partition plate by irradiation heat or conduction heat. Further, a preheating effect can be provided by warming the heating chamber.

(7) The high frequency heating apparatus described in any one of (4) through (6), wherein the high frequency wave from the second high frequency generating portion is introduced into the heating chamber from the upper side feeding port of the heating chamber.

According to the high frequency heating apparatus, the high frequency wave of 5.8 GHz from the second high frequency heating portion is supplied from the upper side feeding port and therefore, the heated object in the heating chamber can uniformly be heated.

(8) The high frequency heating apparatus described in any one of (1) through (7), wherein the heating chamber includes a heating chamber main body having an opening portion, and an opening/closing door for openably and closably covering the opening portion, and at least one of portions of the heating chamber main body and the opening/closing door opposed to each other is formed with a choke for preventing leakage of a radio wave, and wherein the choke shields the high frequency waves respectively from the first high frequency generating portion and the second high frequency generating portion.

According to the high frequency heating apparatus, although the choke is small-sized, when the opening/closing door is closed, the high frequency waves having two kinds of different frequencies supplied to inside of the heating chamber are not leaked.

(9) A method of controlling a high frequency heating apparatus which is a method of controlling a high frequency heating apparatus for heating to process a heated object by supplying a high frequency wave from a high frequency generating portion to a heating chamber containing the heated object, wherein the high frequency wave having a frequency of 2.45 GHz and the high frequency wave having a frequency of 5.8 GHz are simultaneously or alternately supplied from the high frequency generating portion to the heating chamber.

According to the method of controlling the high frequency heating apparatus, by supplying the high frequency wave having the frequency of 2.45 GHz and the high frequency wave having the frequency of 5.8 GHz simultaneously or alternately to the heating chamber, the high frequency wave of 2.45 GHz having the high heating effect and the high frequency of 5.8 GHz the uniform heating effect of which is high can selectively be supplied and therefore, an efficient heating processing can be carried out by supplying a pertinent high frequency wave in accordance with a shape of the heated object or a heating object.

(10) The method of controlling a high frequency heating apparatus described in (9), wherein the high frequency wave having either one of the respective frequencies is outputted at an initial stage of heating and the high frequency wave having other of the respective frequencies is started to output after elapse of a predetermined time period or after reaching a predetermined temperature from starting to heat the heated object.

According to the method of controlling the high frequency heating apparatus, by supplying the high frequency wave having the frequency of 2.45 GHz having the high heating effect at an initial stage of heating to elevate a temperature of the heated object in one motion, further, supplying the high frequency wave having the frequency of 5.8 GHz after elapse of a predetermined time period or after reaching a predetermined temperature, uniform formation of the heating temperature is achieved, and a state of uniformly heating the heated object with a small temperature distribution can be constituted. Further, when the high frequency wave of 5.8 GHz is precedingly supplied and the high frequency wave of 2.45 GHz is successively supplied contrary thereto, there is constituted a heating pattern preferable for cooking or the like of strongly heating the heated object at a latter half of heating.

(11) The method of controlling a high frequency heating apparatus described in (9) or (10), wherein when the high frequency waves having the respective frequencies are simultaneously outputted, an output of at least either one of the respective high frequency waves is restricted such that a total of a drive power for outputting the high frequency waves does not exceed a rated power of the high frequency heating apparatus.

According to the method of controlling the high frequency heating apparatus, when the outputs of the respective high frequency waves exceed the rated power, a total of drive powers for outputting the high frequency waves can be made to be prevented from exceeding the rated power of the high frequency heating apparatus by restricting the output of either one of the high frequency waves.

### BRIEF DESCRIPTION OF THE DRAWINGS

FIG. 1 is a sectional view of a first embodiment of a high frequency heating apparatus according to the invention,

FIG. 2 is a sectional view of a second embodiment of the high frequency heating apparatus according to the invention,

FIG. 3 is a perspective view of a third embodiment of the high frequency heating apparatus according to the invention,

FIG. 4(a) is a cross-sectional view of a wave guide for guiding a microwave of 2.4 GHz, and FIG. 4(b) is a cross-sectional view of a wave guide for guiding a microwave of 5.8 GHz,

FIG. 5 is a perspective view of a fourth embodiment of the high frequency heating apparatus according to the invention,

FIG. 6 is a sectional view taken along a line A-A of FIG. 5,

FIG. 7 illustrates sectional views of a fifth embodiment of the high frequency heating apparatus according to the invention, and FIG. 7(a) and Fig. (b) are views showing electric lines of force of heating distributions which differ from each other,

FIG. 8 is a plane view of a sixth embodiment of the high frequency heating apparatus according to the invention,

FIG. 9 is a diagram comparing heating distribution characteristics of microwaves of 2.4 GHz and 5.8 GHz,

FIG. 10 illustrates views for explaining the high frequency heating apparatus according to the invention, FIG. 10(a) is a vertical sectional view showing an inner structure thereof, FIG. 10(b) shows an example of a state of arranging a feeding port provided at a floor portion,

FIGS. 11(a) through 11(c) are perspective views showing an evaporation bowl of a steam generating portion used in the high frequency heating apparatus of FIG. 1,

FIG. 12 is a constitution diagram of a power source for driving a magnetron of 5.8 GHz used by the invention,

FIG. 13 illustrates an example of applying a wide range wave guide in a shape of a parallelepiped according to the invention to a high frequency heating apparatus, FIG. 13(a) is a front perspective view showing an example of applying the wave guide to a floor portion of the high frequency heating apparatus, FIG. 13(b) is a front perspective view showing an example of applying the wave guide to a ceiling of the high frequency heating apparatus, respectively,

FIG. 14 is a vertical sectional view showing an inner structure of a high frequency heating apparatus of a first background art,

FIG. 15 illustrates views showing an inner structure of a high frequency heating apparatus of a second background art, FIG. 15(a) is a vertical sectional view, FIG. 15(b) is a cross-sectional view passing a wave guide 53 of FIG. 15(a),

FIG. 16 is a conceptual constitution view of a high frequency heating apparatus according to the invention,

FIG. 17 is a constitution diagram of a high frequency driving portion of a high frequency heating apparatus,

FIG. 18 is a perspective view of an outlook of a high frequency heating apparatus for explaining a choke for preventing leakage of radio wave,

FIG. 19 illustrates sectional views showing a section (a) taken along a line A-A of FIG. 3 and a sectional view showing a section (b) taken along a line B-B thereof,

FIG. 20 is a perspective view of a choke,

FIG. 21 illustrates a partial outline section of a high frequency heating apparatus for explaining a stirrer blade,

FIG. 22 illustrates outline sectional views of a high frequency heating apparatus, FIG. 22(a) is an explanatory view showing upper feeding of a high frequency wave of 2.45 GHz, FIG. 22(b) is an explanatory view showing side feeding thereof,

FIG. 23 shows a state of a standing wave at a certain moment appeared in a heating chamber, FIG. 23(a) is an explanatory view showing a high frequency wave of 2.45 GHz, FIG. 23(b) is an explanatory view showing a high frequency wave of 5.8 GHz, FIG. 23(c) is an explanatory view showing a wave synthesized with high frequency waves of 2.45 GHz and 5.45 GHz,

FIG. 24 is a conceptual sectional constitution view of a high frequency heating apparatus dividing a heating chamber upward and downward by a partition plate,

FIG. 25 is a sectional view of a partition plate,

FIG. 26 is a constitution diagram showing other constitution example of a high frequency driving portion,

FIG. 27 is an explanatory view showing patterns for feeding electricity to a first high frequency generating portion, a second high frequency generating portion and showing patterns of alternately outputting high frequency waves of 5.8 GHz and 2.45 GHz,

FIG. 28 is an explanatory view showing patterns of feeding electricity to a first high frequency generating portion, a second high frequency generating portion, and showing patterns of simultaneously outputting high frequency waves of 5.8 GHz and 2.45 GHz,

FIG. 29 is an explanatory view showing patterns of feeding electricity to a first high frequency generating portion, a second high frequency generating portion and showing patterns of precedingly outputting a high frequency wave of 2.45 GHz and succeedingly outputting a high frequency wave of 5.8 GHz,

FIG. 30 is an explanatory view showing a pattern of feeding electricity to a first high frequency generating portion, a second high frequency generating portion, and showing a pattern of outputting only a high frequency wave of 5.8 GHZ.

Further, in notations in the drawings, numeral 1 designates a high frequency heating apparatus, numeral 2 designates a heating chamber, numeral 3 designates a cavity, notation 3a designates an upper wall, notation 3b designates a rear wall (side wall), notation 3c designates a bottom wall, numeral 5 designates a magnetron, numerals 7, 9 designate feeding ports, notations 7a, 7b, 7c designate feeding ports, numeral 11 designates a wave guide, notations 11a, 11b, 11c designate wave guides, numeral 13 designates an outer shell cabinet, numeral 15 designates a front opening/closing door, numerals 21, 31, 41 designate high frequency heating apparatus, numeral 43 designates a face heater, numerals 51, 61 designate high frequency heating apparatus, numeral 110 designates a high frequency heating apparatus according to the invention, numeral 111 designates a heating chamber, notation 111a designates a ceiling of a heating chamber, notation 111b designates a side wall of a heating chamber, notation 111c designates a floor portion, numeral 112 designates a high frequency generating portion, numeral 113 designates a wave guide, notation 113 designates a feeding port, numeral 117 designates a door, numeral 118 designates radio wave leakage preventing means, numeral 131 designates a commercial power source, numeral 132 designates a magnetron, numeral 133 designates a rectifier circuit, numeral 134 designates a choke coil, numeral 135 designates a smoothing capacitor, numeral 136 designates an inverter, numeral 1361 designates an inverter control circuit, numeral 1362 designates a thermistor, numeral 138 designates a step-up transformer, numeral 1381 designates a primary winding, numeral 1382 designates a secondary winding, numeral 1383 designates a filament heating winding, numeral 139 designates a single rectifier circuit, numeral 140 designates a heating cooker, numeral 141 designates a heating chamber, notation 141a designates a ceiling, notation 141b designates a side wall, notation 141c designates a floor portion, numeral 143 designates a high frequency generating portion, numeral 144 designates a wide range wave guide in a shape of a parallelepiped arranged on a floor side, numeral 145 designates a feeding port, numeral 146 designates a wide range wave guide in a shape of a parallelepiped arranged on a side of a ceiling, numeral 147 designates a feeding port, numeral 211 designates a heating chamber, numeral 213 designates a first high frequency generating portion, numeral 215 designates a second high frequency generating portion, numeral 217 designates a high frequency driving portion, numeral 219 designates a control portion, numeral 225 designates a magnetron (for 2.45 GHz), numeral 227 designates a lower side feeding port, numeral 229 designates a lower side wave guide, numeral 231 designates a magnetron (for 5.8 GHz), numeral 233 designates an upper side feeding port, numeral 235 designates an upper side wave guide, numeral 237 designates a first inverter circuit, numeral 267 designates a second inverter circuit, numeral 273 designates a drive control portion, numeral 275 designates an opening/closing door, numeral 277 designates a heating chamber main body, numeral 279 designates a choke, numeral 281 designates a conductor piece, numeral 283 designates a metal plate, numeral 285 designates a groove, numeral 297 designates a partition plate, numerals 2100, 2200 designate high frequency heating apparatus, numeral 2109 designates a change over switch, numeral 2111 designates a drive control portion, notation M designates a heated object.

### BEST MODE FOR CARRYING OUT THE INVENTION

A detailed explanation will be given of a high frequency heating apparatus according to preferable embodiments of the invention in reference to the drawings as follows.

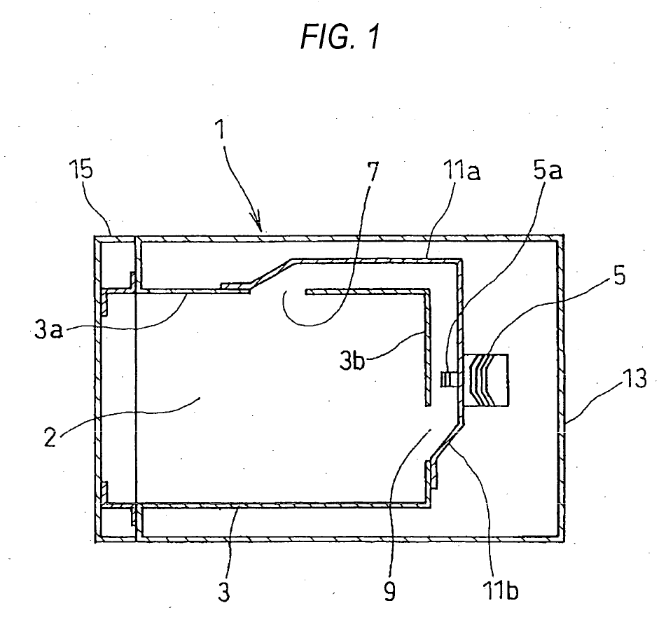

FIG. 1 is a sectional view according to a first embodiment of a high frequency heating apparatus according to the invention.

The high frequency heating apparatus 1 according to the first embodiment can be used as a household microwave oven and is constructed by a constitution including the cavity 3 for partitioning the heating chamber 2, the magnetron 5 which is high frequency generating means for outputting a microwave of 5.8 GHz from an antenna 5a, a plurality of pieces of the wave guides 11a, 11b respectively having the feeding ports 7, 9 for guiding the microwave outputted from the antenna 5a to emit to the heating chamber 2, the outer shell cabinet 13 for ensuring a space of installing the magnetron 5 and the wave guides 11a, 11b at a surrounding of the cavity 3 by surrounding an outer surrounding of the cavity 3, and the front opening/closing door 15 for opening/closing a front face of the heating chamber 2 for bringing a heated object to and from the heating chamber 2.

FIG. 1 is a sectional view in a state of viewing the apparatus from a right side, a left end face of the drawing is the front face of the apparatus, and a lower end face of the drawing is a bottom face of the apparatus.

According to the first embodiment, the magnetron 5 is mounted to an outer face of the rear wall 3b of the cavity 3, the first wave guide 11a is mounted along the upper wall 3a of the cavity 3 constituting an upper face of the heating chamber 2 by being extended upward from the magnetron 5, and the feeding port 7 is opened at substantially a center of the upper wall 3a. Further, the second wave guide 11b is mounted by being extended downward from the magnetron 5, and the feeding port 9 is opened at a position proximate to a lower end of the rear wall 3b of the cavity 3 constituting a rear face of the heating chamber 2.

According to the high frequency heating apparatus 1 constituted in this way, the microwaves are emitted from the respective feeding ports 7, 9 of the respective wave guides 11a, 11b and therefore, a distribution of heating spots by the microwaves can be widened and the microwaves are made to impinge on a portion of a wider range of a surface of the heated object.

As a result, a substantial baking depth can be increased by heating the heated object even by the microwaves of 5.8 GHz having a shallow baking depth from two directions of the heating chamber orthogonal to each other, and an irregularity in heating can be restrained from being brought about over entire regions of a surface layer and an inner deep portion of the heated object without mounting electromagnetic wave stirring means of a turn table, a stirrer fan or the like in the heating chamber 2.

Therefore, even with regard to a thick-walled heated object, excellent heating without an irregularity in heating can be realized, further, by deleting electromagnetic stirring means, simplification of the structure, small-sized formation of the apparatus in accordance therewith, or a reduction in fabrication cost or running cost can be achieved.

Further, in order to compensate for a drawback that the baking depth of the microwave of 5.8 GHz is shallow, from a view point of increasing faces on the heated object on which the microwaves are made to impinge, in arranging the feeding ports for emitting the microwaves, the feeding ports may be mounted dispersingly on a plurality of inner wall faces of the cavity 3, and the arrangement is not limited to that in the above-described embodiment. Further, also a number of mounting the wave guides is not limited to two pieces according to the above-described embodiment. The number can be increased to an arbitrary number of 3 pieces or more.

Specifically, the positions of mounting the feeding ports can be disposed at upper and lower faces of the heating chamber 2, or an upper face and a side face (including a rear face) thereof, or a side face (including a rear face) and a lower face.

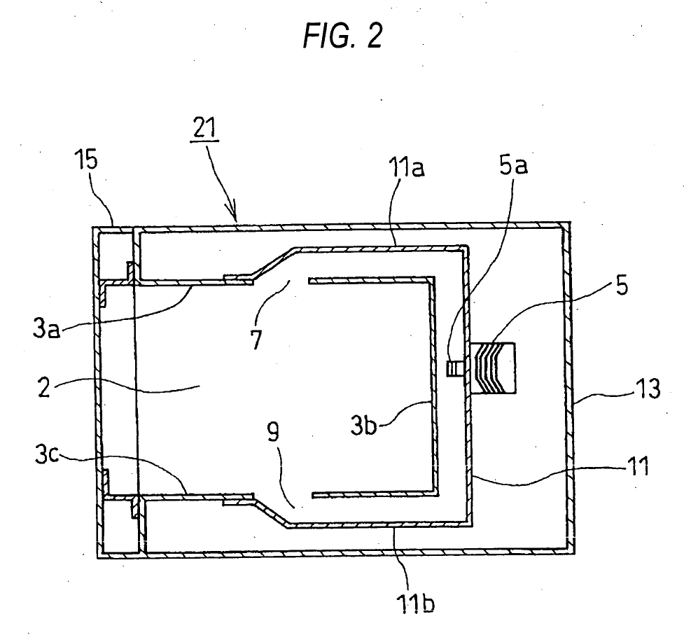

FIG. 2 is a sectional view of a second embodiment of the high frequency heating apparatus according to the invention.

The high frequency heating apparatus 21 of the second embodiment is constructed by a constitution in which the wave guides 11a, 11b are arranged such that the two feeding ports 7, 9 are opened at upper and lower faces of the heating chamber 2, that is, to be opposed to the upper wall 3a and the bottom wall 3c of the cavity 3, although the first wave guide 11a is the same as that of the first embodiment, the second wave guide 11b is mounted along the bottom wall 3c of the cavity 3 constituting the lower face of the heating chamber 2 by being extended downward from the magnetron 5 and the feeding port 9 is opened at substantially a center of the bottom wall 3c.

Further, the second embodiment is constructed by the constitution common to that of the first embodiment other than a change in the positions of mounting the feeding ports 7, 9 and a change in shapes of the wave guides 11a, 11b in accordance therewith and therefore, the common constitution is attached with the same numeral and an explanation thereof will be omitted.

According to the constitution of opposedly arranging the feeding ports 7, 9 at wall faces of the cavity 3 opposed to each other in this way, the substantial baking depth can be increased even by the microwaves of 5.8 GHz having the shallow baking depth by heating the heated object respectively from two directions opposed to each other, even when electromagnetic wave stirring means of a turn table, a stirrer fan or the like is not mounted in the heating chamber 2, an irregularity in heating can be restrained from being brought about over entire regions of the surface layer and the inner depth portion of the heated object, similar to the first embodiment, excellent heating without an irregularity in heating can be realized even for the thick-walled heated object, further, by deleting electromagnetic wave stirring means, simplification of the structure and small-sized formation of the apparatus in accordance therewith, or a reduction in fabrication cost or running cost can be achieved.

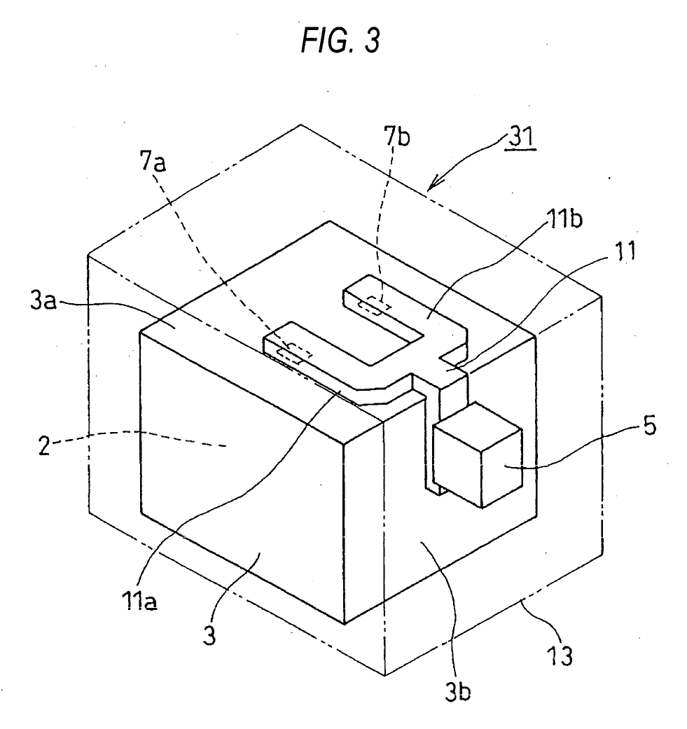

FIG. 3 is a perspective view of a third embodiment of the high frequency heating apparatus according to the invention viewed from a rear side.

The high frequency heating apparatus 31 of the third embodiment is constructed by a constitution of providing two pieces of the feeding ports 7a, 7b at the upper face of the heating chamber 2 by two pieces of the wave guides 11a, 11b arranged at the upper wall 3a of the cavity 3. Two pieces of the wave guides 11a, 11b are formed by bifurcating a single piece of the common tube 11 extended upward from the magnetron 5.

According to the constitution, impingement of the microwaves from the upper face to the heated object contained in the heating chamber 2 can uniformly be dispersed over a wide range and it can be expected to considerably increase a heating distribution to the upper face of the heated object.

Further, by combining a constitution of providing a feeding port at a side face (including rear face) or a bottom face of the heating chamber 2 to the constitution of mounting two pieces of the feeding ports 7a, 7b to the upper face of the heating chamber 2 as in FIG. 3, a performance of uniformly heating the heated object can further be promoted.

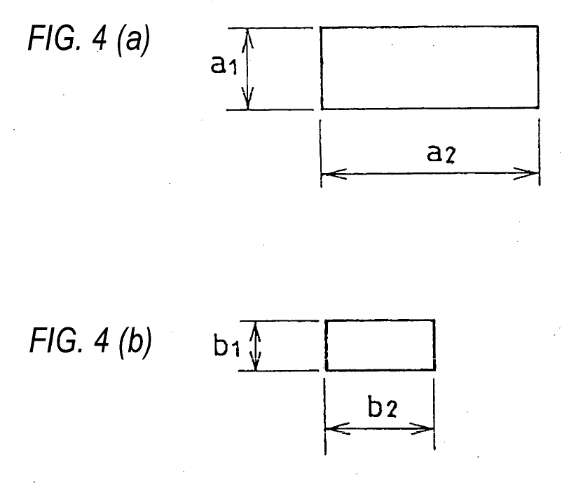

Further, FIG. 4(a) is a cross-sectional view of a wave guide for guiding a microwave of 2.45 GHz, and FIG. 4(b) is a cross-sectional view of a wave guide for guiding a microwave of 5.8 GHz. The respective cross-sectional views are drawn by the same contraction scale.

As illustrated, a cross-sectional area of the wave guide for guiding the microwave of 5.8 GHz is contracted to about ¼ of a cross-sectional area of the wave guide for guiding the microwave of 2.45 GHz. Therefore, a long side dimension b2 of the wave guide for 5.8 GHZ becomes substantially the same as a short side dimension a1 of the wave guide for 2.45 GHz.

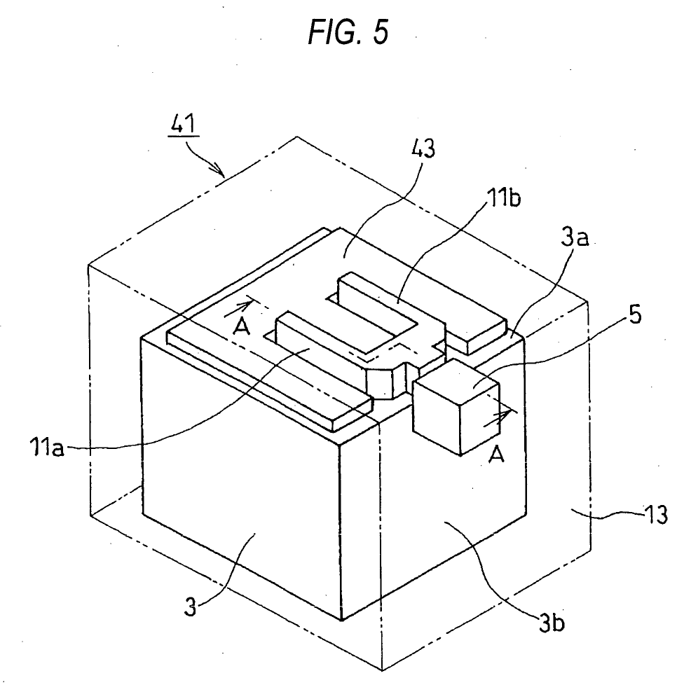

FIG. 5 is a perspective view of a fourth embodiment of the high frequency heating apparatus according to the invention viewed from a rear side.

The high frequency heating apparatus 41 of the fourth embodiment is constituted by further improving the high frequency heating apparatus 31 shown in FIG. 3 in consideration of the dimensional difference between the wave guides shown in FIG. 4, two pieces of the wave guides 11a, 11b arranged at the upper wall 3a of the cavity 3 are mounted by a vertical arrangement in which the long side b2 of a cross-sectional face of the wave guide is directed in an up and down direction, further, the face heater 43 is arranged at a region of the upper wall 3a of the cavity 3 excluding a region of mounting the wave guides arranged vertically.

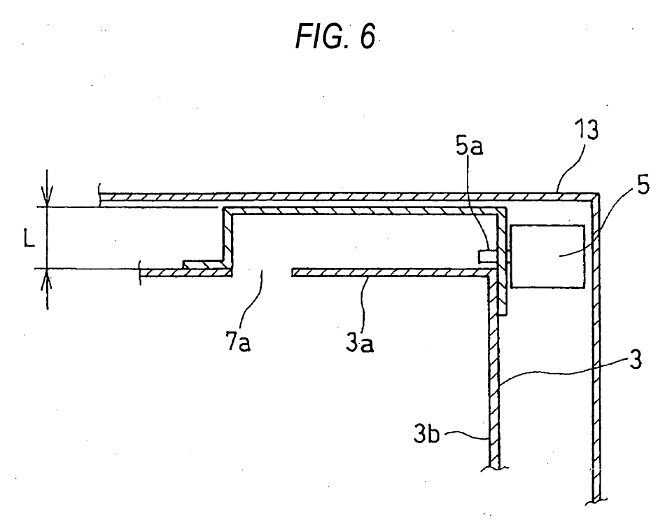

When the frequency of the microwave used is 5.8 GHz, in this way, even when the wave guides 11a, 11b arranged at the upper wall 3a of the cavity 3 are vertically arranged, as shown by FIG. 6, a space L of installing the wave guides ensured on the upper face side of the cavity 3 can be set to be equivalent to that of the high frequency heating apparatus of the background art in which the wave guide for 2.45 GHz is installed to the upper face of the cavity 3 by directing the long side horizontally. Further, by vertically arranging the wave guide, by reducing an occupied area of the wave guide at the upper wall 3a of the cavity 3 in a width direction, the occupied area can be reduced.

As a result, a vacant area of the upper wall 3a of the cavity 3 is increased and as shown by FIG. 5, there can be constructed a constitution of arranging the face heater 43 over an entire region of a large vacant region of the upper wall 3a of the cavity 3 excluding a region of mounting the wave guides 11a, 11b.

That is, the face heater 43 can be mounted by a larger area, and oven heating without an irregularity in heating can be realized by making a temperature distribution in an oven heating processing by operating the face heater 43 uniform over a wider region.

Further, the position of vertically arranging the wave guide as described above is not limited to the upper wall 3a of the cavity 3.

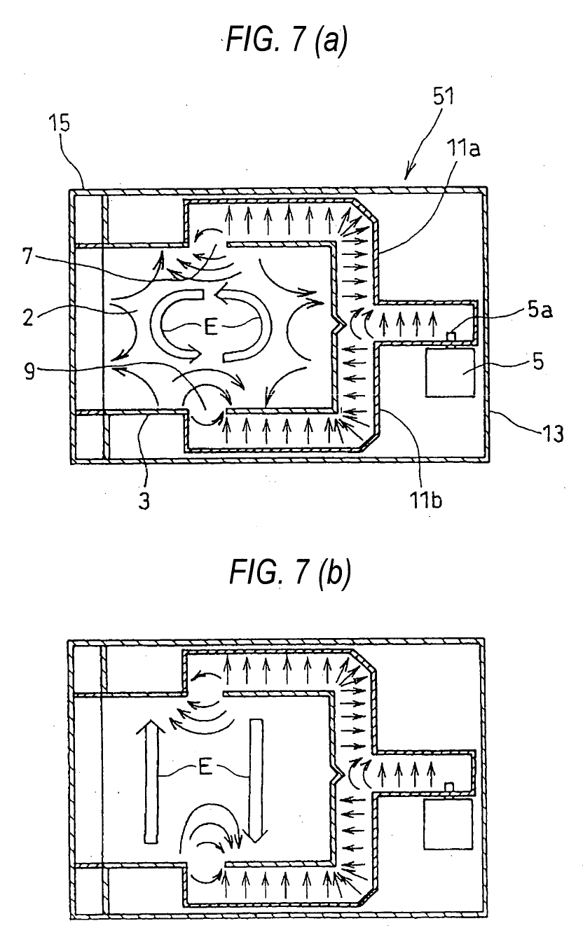

FIGS. 7(a) and (b) are sectional views of a fifth embodiment of the high frequency heating apparatus according to the invention. Further, FIGS. 7(a) and (b) show examples of different heating distributions in the heating chamber by electric lines of force.

According to the high frequency heating apparatus 51 of the fifth embodiment, in the constitution of arranging two pieces of the wave guides 11a, 11b opposedly to upper and lower faces of the heating chamber 2 as previously shown in FIG. 2, the wave guides 11a, 11b are respectively set to be arranged vertically.

According to the constitution, microwaves irradiated from the respective feeding ports 7, 9 opposed to each other upward and downward form standing waves phases of which are shifted from each other by 180° and therefore, further uniform formation of the heating distribution with regard to the heated object can be expected.

Describing further, by shifting the phases of the microwaves irradiated from the respective upward and downward feeding ports 7, 9 by 180°, both of the microwaves can align a direction of an electric field in one direction. Thereby, as shown by FIGS. 7(a) and (b), heating of the heated object can be promoted by an electric field intensity constituted by adding those of both electric fields. Further, as shown by FIG. 7(b), more microwave energy can be transmitted to an inner portion of a food product.

Further, although it is difficult to arbitrarily selecting FIGS. 7(a) and (b) in accordance with the heated object, it can be expected that either of FIGS. 7(a) and (b) is brought about as a change over time in accordance with progress of heating of the heated object and therefore, uniform formation of heating can be promoted.

Further, when the cavity 3 is mounted with a plurality of pieces of the wave guides, the mounting number is not limited to two pieces shown in the above-described embodiment but can be improved to an arbitrary number.

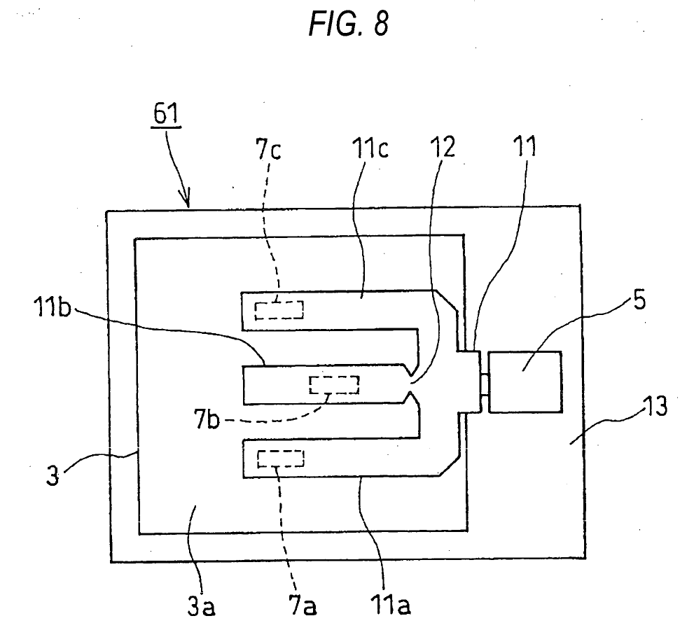

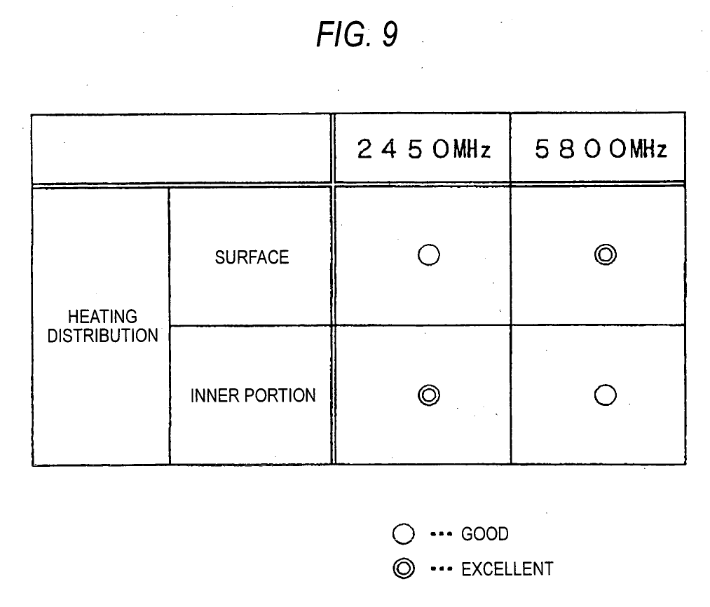

FIG. 8 is a plane view of an upper face of the cavity of a sixth embodiment of the high frequency heating apparatus according to the invention.

The high frequency heating apparatus 61 is mounted with three pieces of the feeding ports 7a, 7b, 7c by the trifurcated wave guides 11a, 11b, 11c at the upper wall 3a of the cavity 3, further, according to three pieces of the feeding ports 7a, 7b, 7c, a position of the center feeding port 7b is shifted from those of the other feeding ports 7a, 7c. Further, the center wave guides 11b is narrowed at a branch base portion 12 into a mode of contracting a cross-sectional area in comparison with those of the other wave guides 11a, 11c. Further, all of three pieces of the wave guides are arranged vertically.

Thereby, irradiation of the microwaves from the upper face of the heating chamber 2 can further uniformly be diffused over a wide region of the heating chamber 2 by a high density and an irregularity in heating with regard to the heated object can further be prevented. Further, the reason of narrowing the center wave guide 11b is that the center wave guide 11b is linearly extended from the magnetron 5 and an efficiency of guiding the microwave is higher than those of the wave guides 11a, 11c and therefore, the center wave guide 11b is balanced with the other wave guides 11a, 11c by restricting the efficiency.

A detailed explanation will be given of a seventh embodiment of the invention as follows.

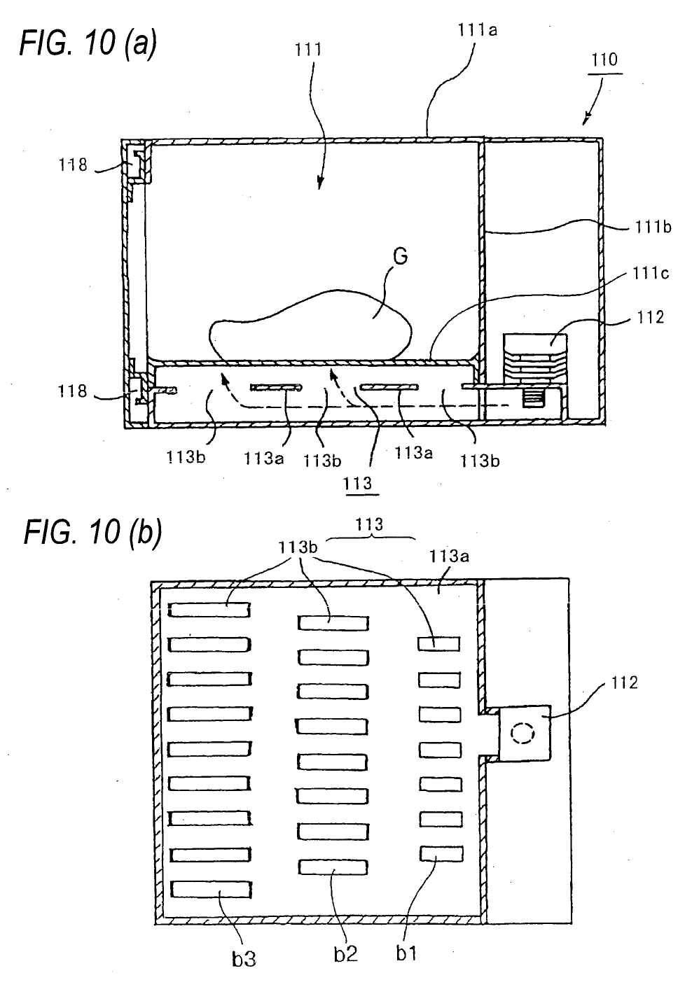

FIG. 10 illustrates views for explaining the high frequency heating apparatus according to the invention, FIG. 10(a) is a vertical sectional view showing an inner structure thereof, FIG. 10(b) shows an example of a state of arranging a feeding port provided at a floor portion.

In FIG. 10(a), numeral 110 designates the high frequency heating apparatus according to the invention, numeral 111 designates the heating chamber, notation 111a designates the ceiling of the heating chamber, notation 111b designates the side wall of the heating chamber, notation 111c designates the floor portion. The floor portion 111c comprises a material which is not a metal, for example, ceramic. Numeral 112 designates the high frequency generating portion provided on an outer side of a rear side of the floor portion 111c of the heating chamber 111 for oscillating the microwave having the frequency of 5.8 GHz, numeral 113 designates the wave guide provided on the rear side of the floor portion 111c of the heating chamber 111 and a so-to-speak wide range wave guide in a shape of a parallelepiped a shape of which is constituted by a parallelepiped (for example, longitudinal length 30 cm×lateral length 30 cm×height 5 cm). An area of a wide face of the six faces substantially coincides with an area of the floor portion 111c. Further, notation 113a designates a wave guide ceiling (face opposed to the floor portion 111c), notation 113b designates a number of feeding ports formed substantially over an entire face of the wave guide ceiling 113a. Numeral 117 designates the door, numeral 118 designates radio wave leakage preventing means having a choke structure provided at four sides of the door 117 in correspondence with a quarter wave length of the microwave.

FIG. 10(b) shows one arrangement example of the feeding ports formed substantially over an entire face of the wave guide ceiling 113a. Here, each feeding port 113b is constituted by a rectangle a long side of which is provided with a length equal to or larger than ¼λ (about 1.3 cm) and 7 pieces thereof are provided at a row proximate to the high frequency generating portion 112, 8 pieces thereof are provided at a successive row and 9 pieces thereof are provided at a row remote from the high frequency generating portion 112.

By constituting a state of arranging a number of pieces of the feeding ports in this way, a microwave having a strong electric field intensity proximate to the high frequency generating portion 112 is brought into the heating chamber 111 by a small amount, a microwave having a weak electric field intensity remote from the high frequency generating portion 112 is brought into the heating chamber 111 by a large amount and therefore, a comparatively uniform electric field intensity is constituted in the heating chamber 111, which contributes to uniform heating of the heated object G.

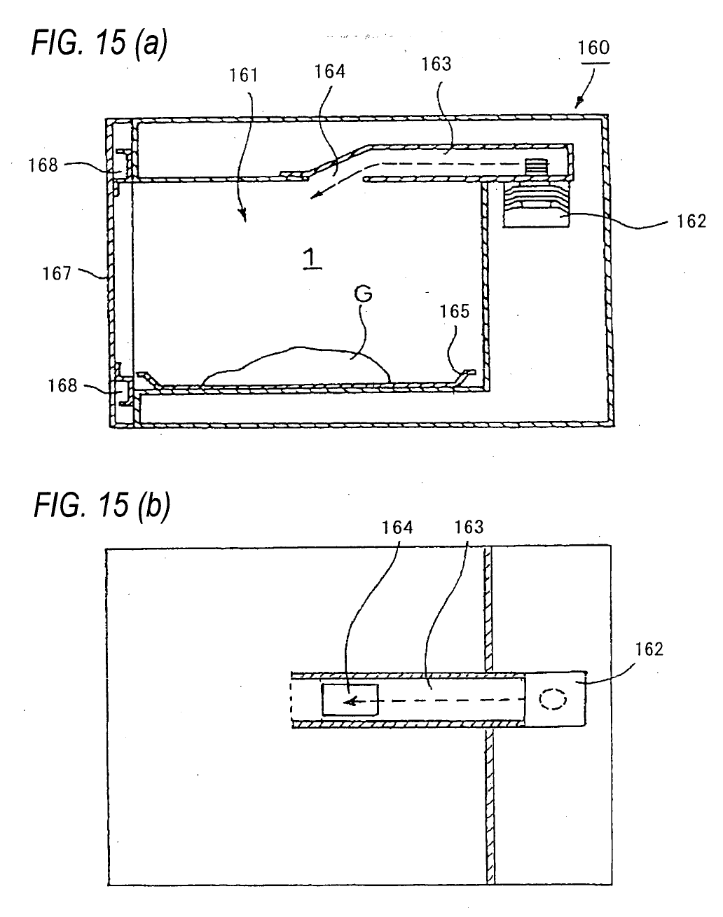

In contrast thereto, as shown by FIG. 15(b), the wave guide 113 of the background art is constituted by a slender pipe and is provided with one piece of the feeding port 154 and therefore, it is difficult to achieve a uniform electric field intensity in the heating chamber 111 and therefore, uniform heating of the heated object G is difficult.

Further, according to the invention, a size of a hole of the feeding port 113b1 at the row proximate to the high frequency generating portion 112 is made to be smaller and the size is made to be larger in accordance with being remote from the high frequency generating portion 112 and therefore, a microwave having the strong electric field intensity proximate to the high frequency generating portion 112 is brought into the heating chamber 111 by a small amount, the microwave having the weak electric field intensity remote from the high frequency generating portion 112 is brought into the heating chamber 111 by a large amount and therefore, a comparatively uniform electric field intensity is constituted in the heating chamber 111, which contributes to uniform heating of the heated object G.

Operation of the high frequency heating apparatus 110 is as follows.

When the magnetron 112 is driven, a microwave having the frequency of 5.8 GHz is oscillated from the magnetron 112. The oscillated microwave having the frequency of 5.8 GHz is brought to an entire face of the rear side of the floor portion 111c by passing the wave guide 113 provided at a total of the rear side of the floor portion 111c of the heating chamber 111, brought into the heating chamber 111 from a number of the respective feeding ports 113b scatteringly provided at the wave guide 113, further, a number of pieces and the sizes of holes of the feeding ports 113b are determined unproportionally to the electric field intensity and therefore, as a result, a uniform electric field intensity is constituted in the heating chamber and therefore, thereby, the heated object G is heated without an irregularity in heating.

Further, also a structure of the wave guide is simply constituted by the parallelepiped and is solid, promotes reliability and reduces cost.

Further, the wide range wave guide 113 in the shape of the parallelepiped is formed at a space which is vacant in the background art on the rear side of the floor portion and therefore, the space can effectively be utilized and a volume of a space in the heating chamber can be increased by an amount of a space of the wave guide 153 provided at the ceiling of the heating chamber 151 in FIG. 15.

Further, since the feeding port is proximate to the food product constituting the heated object, absorption of a radio wave is improved.

Further, in the case of an microwave oven having a heater, arrangement of an upper heater is much simplified.

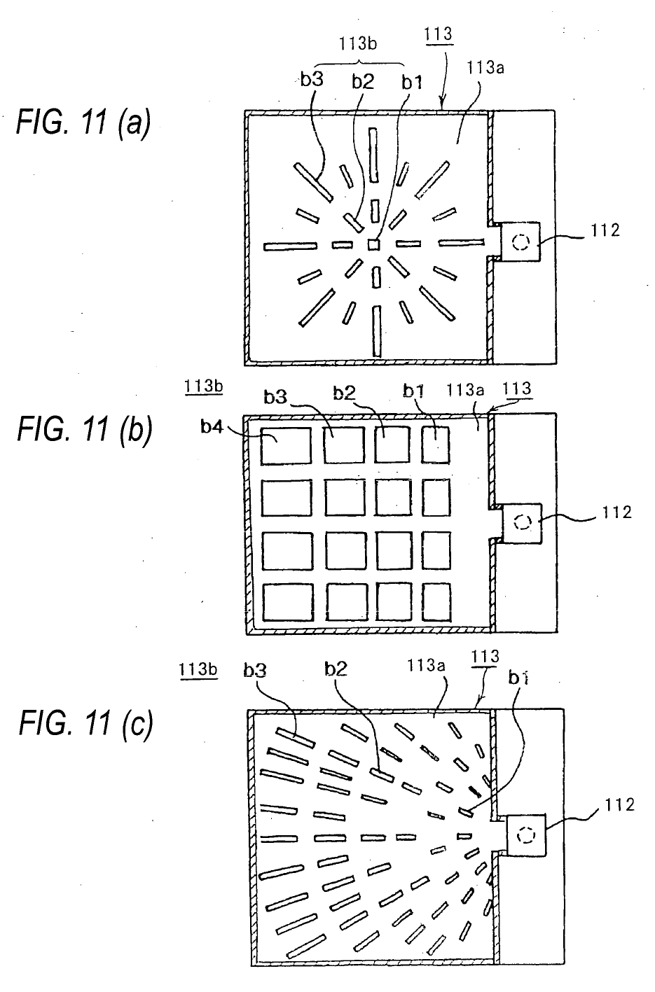

FIG. 11 shows an example of other arrangement of feeding ports provided at a ceiling of a wave guide of a wide range wave guide in a shape of a parallelepiped.

FIG. 11(a) shows a wide range wave guide in a shape of a parallelepiped having feeding ports arranged radially.

In the drawing, numeral 112 designates the high frequency generating portion, numeral 113 designates the wide range wave guide in the shape of the parallelepiped, notation 113a designates the ceiling, notation 113b designates the feeding port opened at the ceiling 113a, notations b1 through b3 respectively designate holes having different sizes.

The feeding ports b1 through b3 in a shape of a long hole are radially arranged from a center of the wave guide ceiling 113a of the heating chamber 111. Further, as is known by comparing the feeding ports b1 and b3, the remoter from the center, the longer the long hole.

As a result, a uniform electric field distribution is constituted up to a corner portion which the microwave is comparatively difficult to reach and the heated object G is heated without an irregularity in heating regardless of an area thereof.

FIG. 11(b) shows a wide range wave guide in a shape of a parallelepiped having feeding ports in an arrangement in a shape of a checkerboard.

In the drawing, numeral 112 designates the high frequency generating portion, numeral 113 designates the wide range wave guide in the shape of the parallelepiped, notation 113a designates the ceiling, notation 113b designates the feeding port opened at the ceiling 113a, and notations b1 through b4 designate holes respectively having different sizes.

The feeding ports b1 through b4 in a rectangular shape are arranged in a shape of a checkerboard on the wave guide ceiling 113a of the heating chamber 111. Further, as is known by comparing the feeding ports b1a and b4, the remoter from the wide of the high frequency generating portion 112, the longer the side of the feeding port.

As a result, a uniform electric field distribution is constituted up to a portion on a side opposed to a portion of installing the high frequency generating portion 112 and a portion which the microwave is comparatively difficult to reach and the heated object G is heated without an irregularity in heating regardless of an area thereof.

FIG. 11(c) shows a wide range wave guide in a shape of a parallelepiped having feeding ports arranged radially.

In the drawing, numeral 112 designates the high frequency generating portion, numeral 113 designates the wide range wave guide in the shape of the parallelepiped, notation 113a designates the ceiling, notation 113b designates the feeding port opened at the ceiling 113a, and notations b1 through b3 designate holes respectively having different sizes.

The feeding ports b1 through b3 in a rectangular shape are radially arranged from the high frequency generating portion 112 on the wave guide ceiling 113a. Further, it is known by comparing the feeding ports b1 and b3, the remoter from the center, the longer the long hole.

As a result, a uniform electric field distribution is constituted up to a portion on a side opposed to a portion of installing the high frequency generating portion 112 and a portion which the microwave is comparatively difficult to reach and the heated object G is heated without an irregularity in heating regardless of an area thereof.

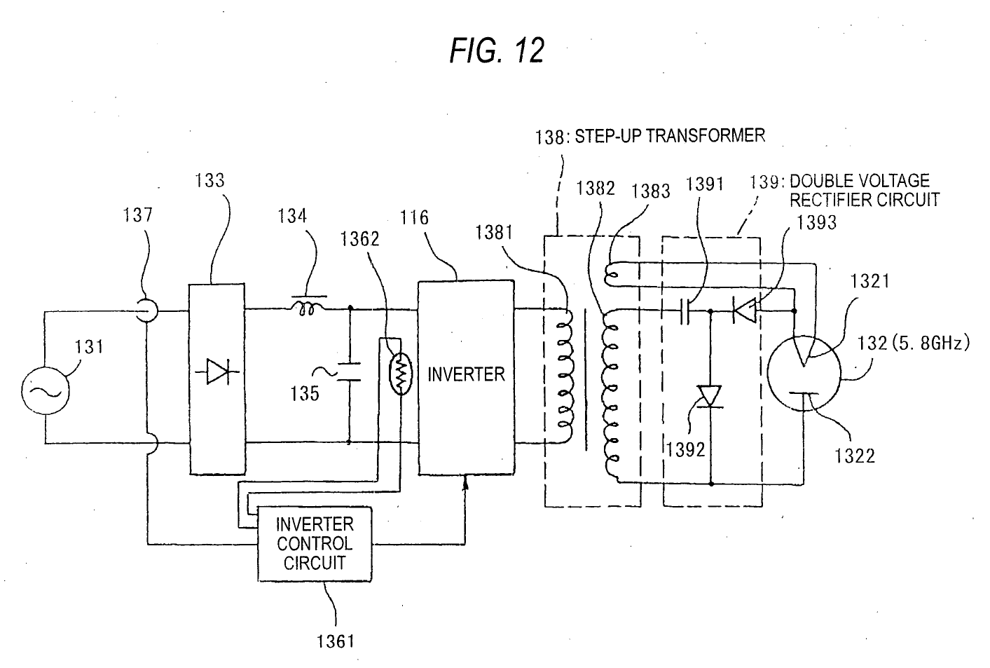

FIG. 12 is a constitution diagram of a power source for driving the magnetron of 5.8 GHz used in the invention. In the drawing, an alternating current from the commercial power source 131 is rectified into a direct current by the rectifier circuit 133, smoothed by the choke coil 134 and the smoothing capacitor 135 on an output side of the rectifier circuit 133 and is inputted to an input side of the inverter 136. The direct current is converted into a desired high frequency wave (20 through 40 kHz) by ON/OFF of a semiconductor switching element in the inverter 136. The inverter 136 is controlled by IGBT (Insulated Gate Bipolar Transistor) for switching the direct current at high speed and the inverter control circuit 1361 for controlling to drive the IGBT and a current flowing on a primary side of the step-up transformer 138 is switched ON/OFF at high speed.

As an input signal of the control circuit 1361, a primary side current of the rectifier circuit 133 is detected by CT 137 and the detected current is inputted to the inverter control circuit 1361 and is used to control the inverter 136. Further, a cooling fin for cooling IGBT is attached with a temperature sensor (thermistor) 1362 and detected temperature information by the temperature sensor is inputted to the inverter control circuit 1361 and is used for controlling the inverter 136.

In the step-up transformer 138, the primary winding 1381 is applied with a high frequency voltage which is an output of the inverter 136 and a high voltage in accordance with the turn ratio is provided at the secondary winding 1382. Further, a winding 1383 having a small turn number is provided on the secondary side of the step-up transformer 138 and is used for heating the filament 1321 of the magnetron 132 for oscillating 5.8 GHz. The secondary winding 1382 of the step-up transformer 138 is provided with a double voltage single way rectifier circuit 139 for rectifying an output thereof. The double voltage single way rectifier circuit 139 is constituted by a high voltage capacitor 1391 and two pieces of high voltage diodes 1392, 1393.

By the circuit having the above-described constitution, the alternating current is rectified and smoothed, converted into the high frequency wave at the inverter, the voltage is transformed into the high voltage at high frequency by the high voltage transformer, thereafter, the high voltage is rectified and the magnetron is driven. When the magnetron is driven, the microwave of 5.8 GHz is oscillated from the antenna, the microwave of 5.8 GHz is conducted through the wide wave guide constituted by substantially the entire face of the rear side of the floor portion of the heating chamber and is brought into the heating chamber from the optimum feeding port while repeating reflection at the wall face of the wave guide.

Therefore, substantially the total of the rear side of the floor portion constitutes the wave guide structure, a number of pieces of the feeding ports for passing the high frequency wave into the heating chamber are provided substantially over the total face of the floor portion and therefore, there is not brought about a difference in the electric field intensity of the microwave between the center and the corner of the heating chamber to enable to be proximate to uniform heating. Further, the wave guide is provided on this side to be aligned with a steam generating apparatus provided at the corner on the rear side of the floor portion and therefore, a wasteful space is eliminated and the space volume in the heating chamber can be increased by an amount of the space of the rear side of the ceiling installed with the wave guide of the background art.

By using the magnetron for oscillating the high frequency wave having the frequency of 5.8 GHz in this way, the wavelength becomes about 5 cm and therefore, the wavelength is smaller in comparison with the wide range wave guide in the shape of the parallelepiped according to the invention and therefore, the microwave is easy to be irradiated in the wide range wave guide in the shape of the parallelepiped, and uniform formation of heating can be achieved by randomly distributing the microwaves.

Although in the above-described explanation, as the magnetron used, the magnetron having the frequency of 5.8 GHz is used, the invention is not limited thereto but the magnetron used may be a general purpose magnetron of 2.45 GHz. However, in the latter case, the wavelength is about 12 cm and therefore, the wavelength is large in comparison with a size of the wide range wave guide in the shape of the parallelepiped according to the invention and therefore, the microwave needs to be devised to be distributed in the wide range wave guide in the shape of the parallelepiped.

According to the invention, the uniform formation can be achieved by making numbers of pieces and sizes of holes of the feeding ports depend on the distance from the magnetron and therefore, also in the case of the magnetron of 2.45 GHz, by carefully selecting the numbers of pieces and sizes of holes of the feeding ports, uniform heating can be carried out.

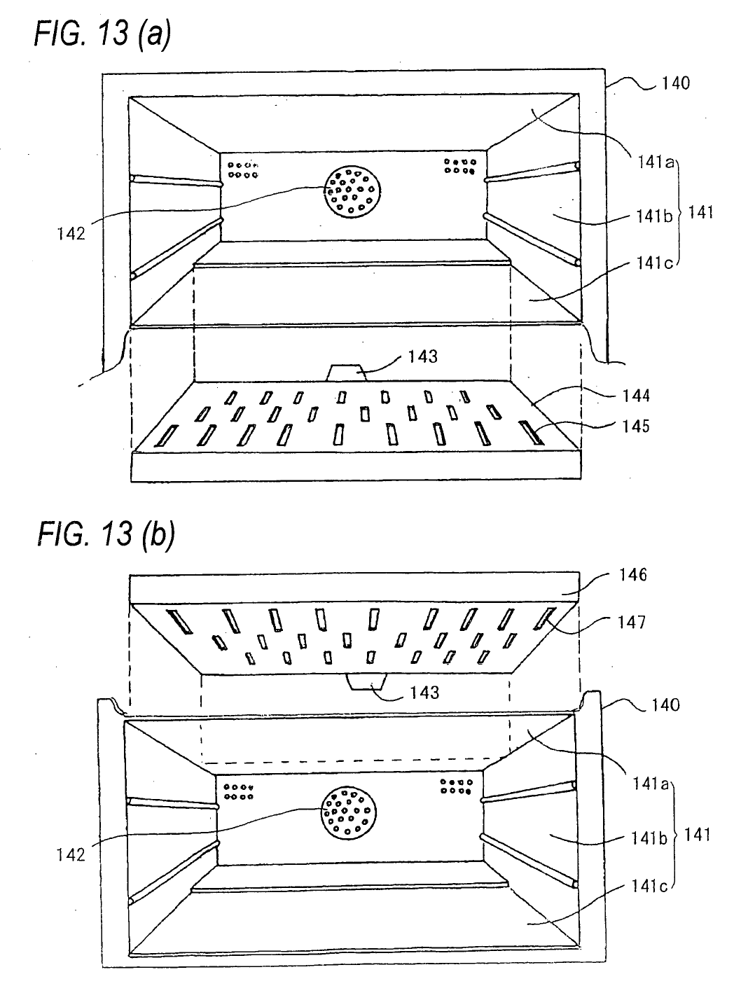

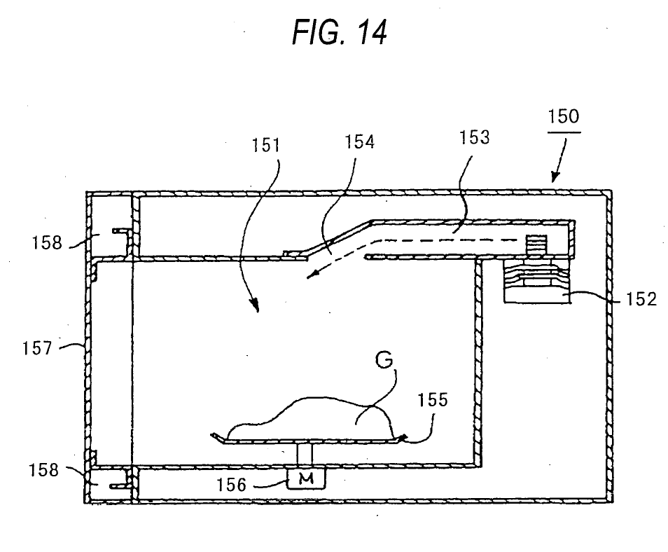

FIG. 13 illustrates front perspective views showing an example of applying the wide range wave guide in the shape of the parallelepiped according to the invention to the high frequency heating apparatus, FIG. 13(a) is a front perspective view showing an example of applying the wide range wave guide in the shape of the parallelepiped to the floor portion of the high frequency heating apparatus and FIG. 13(b) is a front perspective view showing an example of applying the wide range wave guide in the shape of the parallelepiped to the ceiling of the high frequency heating apparatus, respectively. In the drawings, the door is omitted and the wide range wave guide in the shape of the parallelepiped is shown in a state of being removed from the main body of the heating apparatus.

In FIG. 13(a), numeral 140 designates the heating cooker for heating to process the heated object by supplying the microwave to the heating chamber. Numeral 141 designates the heating chamber which is constituted by the ceiling 141a, the side wall 141b and the floor portion 141c. Numeral 142 designates a circulating fan for circulating air in the heating chamber 141, numeral 143 designates the high frequency generating portion including the magnetron, numeral 144 designates the wide range wave guide in the shape of the parallelepiped according to the invention, numeral 145 designates the feeding port.

The heating chamber 141 is formed at inside of a main body case in a shape of a box a front face of which is opened and a front face of the main body case is provided with an opening/closing door (not illustrated) for opening/closing a port of taking out the heated object. The opening/closing door is made to be able to be opened/closed in an up and down direction by coupling a lower end to a lower edge of the main body case by a hinge.

A size of the wide range wave guide 144 in the shape of the parallelepiped is constituted by a size equal to substantially a total face of the floor portion 141 according to the invention. The wave guide of the background art is constituted by a slender pipe the section of which is rectangular and the width of which is equal to the width of the high frequency generating portion and is provided with a single piece of the feeding port and therefore, it is difficult to achieve the uniform electric field intensity in the heating chamber and therefore, uniform heating of the heated object G is difficult, however, according to the wide range wave guide 144 in the shape of the parallelepiped, a large number of the feeding ports 145 are scattered on the floor side, the size is smaller at the vicinity of the high frequency generating portion 143, the remoter from the high frequency generating portion 143, the larger the size and therefore, the heated object placed at the floor portion is heated thermally efficiently and can be heated uniformly.

Further, by arranging the wide range wave guide 113 in the shape of the parallelepiped particularly at the floor portion, a space volume in the heating chamber can be increased, further, the feeding port becomes proximate to the food product which is the heated object and therefore, absorption of radio wave is improved. Further, in the case of a model of an microwave oven having a heater, there is also achieved an effect of much simplifying arrangement of an upper heater.

In FIG. 13(b), numeral 140 similarly designates the heating cooker, numeral 141 designates the heating chamber, numeral 142 designates the circulating fan, numeral 143 designates the high frequency generating portion, numeral 146 designates the wide range wave guide in the shape of the parallelepiped, numeral 147 designates the feeding port.

The size of the wide range wave guide 146 in the shape of the parallelepiped is constituted by a size substantially equal to a total face of the ceiling 141a according to the invention, a large number of the feeding ports 147 are scattered on the ceiling side, the size is smaller at the vicinity of the high frequency generating portion 143, the remoter from the high frequency generating portion 143, the larger the size and therefore, uniform radio waves fall from the single face of the ceiling as in the shower and therefore, further uniform heating can be carried out.

Further, by arranging the wide range wave guide 113 in the shape of the parallelepiped particularly at the ceiling, a sufficient space can be produced below the floor and therefore, when a food product is automatically heated, a weight sensor for detecting a weight of the food product is easy to be arranged, further, in the case of a model of using a turn table, the turn table can simply be constituted.

A detailed explanation will be given of a preferable embodiment of a high frequency heating apparatus and its control method according to the invention as an eighth embodiment in reference to the drawing as follows.

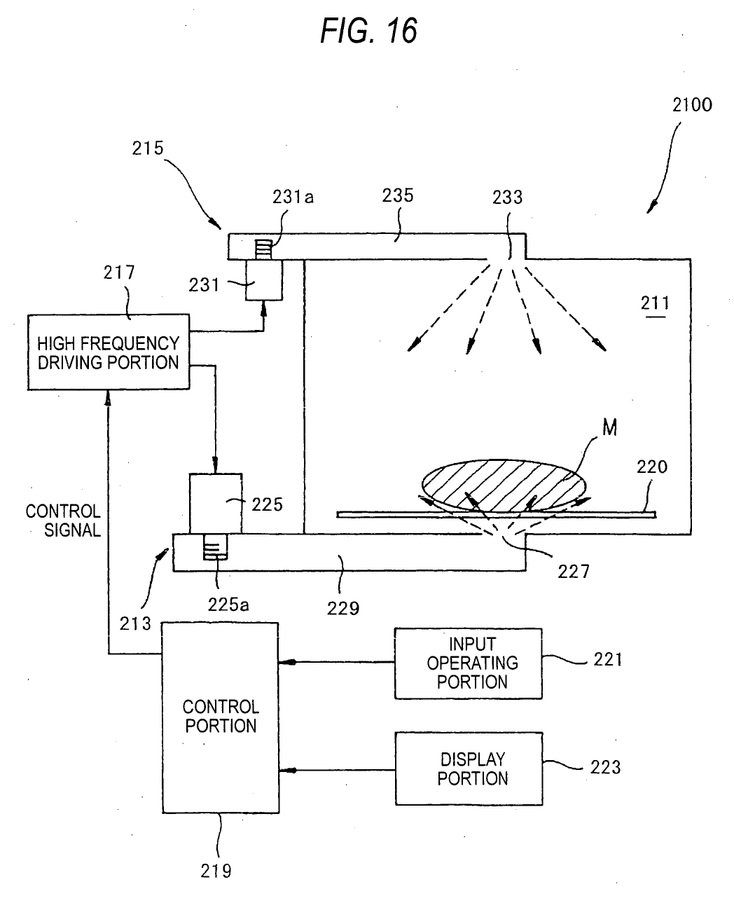

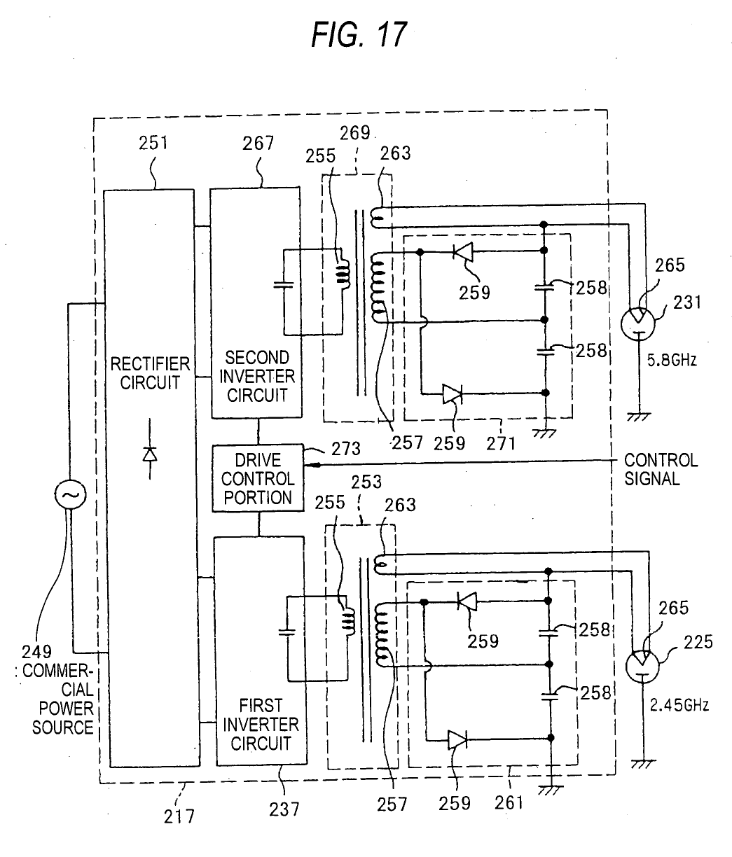

FIG. 16 is a conceptual constitution diagram of the high frequency heating apparatus according to the invention, and FIG. 17 is a constitution diagram of a high frequency driving portion of the high frequency heating apparatus.

As shown by FIG. 16, the high frequency heating apparatus 2100 heats to process the heated object M by supplying the high frequency wave to the heating chamber 211 containing the heated object M and is provided with the first high frequency generating portion 213 for generating the high frequency wave having the frequency of 2.45 GHz and the second high frequency generating portion 215 for generating the high frequency wave having the frequency of 5.8 GHz. Further, the high frequency heating apparatus 2100 is provided with the high frequency driving portion 217, the control portion 219 for driving to oscillate the first and the second high frequency generating portions, and the control portion 219 is connected with an input operating portion 221 of a start switch for instructing to start heating, a menu switch for setting content of heating and the like, and a display portion 223 for displaying various information. The control portion 219 heats the heated object M on a mounting base 220 under a desired condition by controlling to drive the high frequency generating portions based on an input content from the input operating portion 221.

The first high frequency generating portion 213 includes the magnetron 225 for oscillating the high frequency wave having the frequency of 2.45 GHz, and the lower side wave guide 229 for guiding the high frequency wave outputted from an antenna 225a of the magnetron 225 to the lower side feeding port 227 provided on the bottom face side of the heating chamber 211.

Further, similarly, the second high frequency generating portion 215 includes the magnetron 231 for oscillating the high frequency wave having the frequency of 5.8 GHz, and the upper side wave guide 235 for guiding the high frequency wave outputted from an antenna 231a of the magnetron 231 to the upper side feeding port 233 provided on an upper face side of the heating chamber 211.

The high frequency driving portion 217 is provided with the inverter circuit for individually driving the respective magnetrons 225, 231 as shown by an example in FIG. 17. The first inverter circuit 237 for driving the magnetron 225 is supplied with a power from a commercial power source 249 by being subjected to full-wave rectification by a rectifier circuit 251 of a diode bridge or the like, converts the power into a high frequency voltage and thereafter supplies the high frequency voltage to a primary winding 255 of a step-up transformer 253. Then, a high voltage having a high frequency of several kV is generated at a secondary winding 257 of the step-up transformer 253. Further, the high voltage having the high frequency is rectified by a double voltage rectifier circuit 261 comprising a capacitor 258 and a diode 259 and the magnetron 225 is applied with the high voltage. Further, a heater winding 263 of the step-up transformer 253 is connected to a filament 265 of the magnetron 225 to heat the filament 265. Further, the magnetron 225 oscillates the high frequency by being heated by the filament 265 and applied with the high voltage.

The respective constitutions of the first inverter circuit 237, the step-up transformer 253 and the double voltage rectifier circuit 261 for driving the magnetron 225 are similar to constitutions of the second inverter circuit 267, a step-up transformer 269, and a double voltage rectifier circuit 271 for driving the magnetron 231 and therefore, portions having the same functions are attached with the same notations to thereby omit the explanation.

Further, the first inverter circuit 237 and the second inverter circuit 267 are connected with the drive control portion 273 and the drive control portion 273 controls drive timings and a power feeding distribution or the of the both circuits by receiving a control signal from the control portion 219.

Here, an explanation will be given of a choke for preventing leakage of radio wave with regard to the high frequency waves having two kinds of the frequencies supplied to the heating chamber 211.

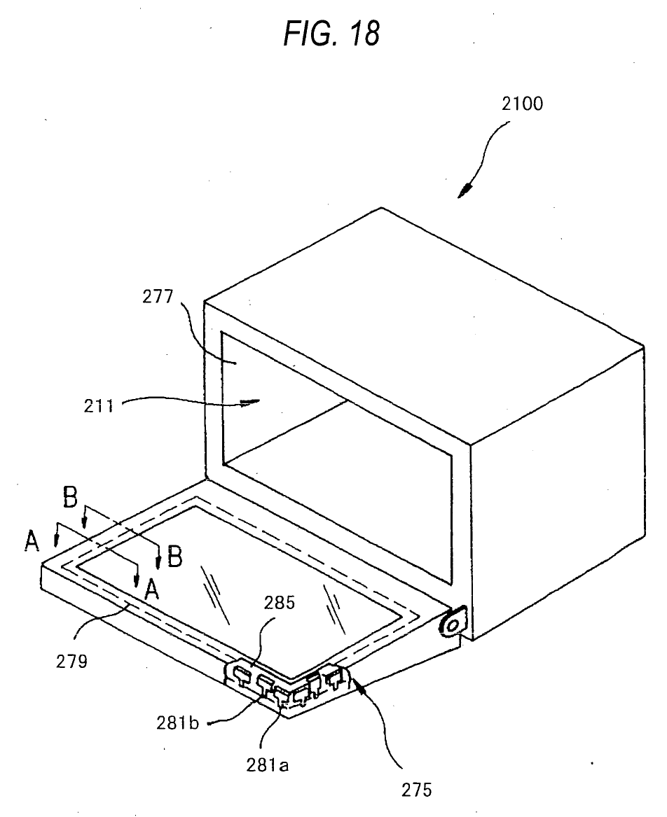

FIG. 18 shows a perspective view of an outlook of the high frequency heating apparatus 2100. The heating chamber 211 in a shape of a box is constructed by a constitution of being opened by the opening/closing door 275 openably/closably attached to a front face side constituting a side face of the high frequency heating apparatus 2100 and enabling to bring the heated object to and from the heating chamber 211 via the opening portion. That is, according to the heating chamber 211, the heating chamber main body 277 having the opening portion is made to be openable/closable by the opening/closing door 275 and therefore, the choke 279 for preventing leakage of radio wave of the opening/closing door 275 is provided at a portion of the opening/closing door 275 opposed to the heating chamber main body 277. The choke 279 may be formed at a portion on the side of the heating chamber main body 277 opposed to the opening/closing door 275.

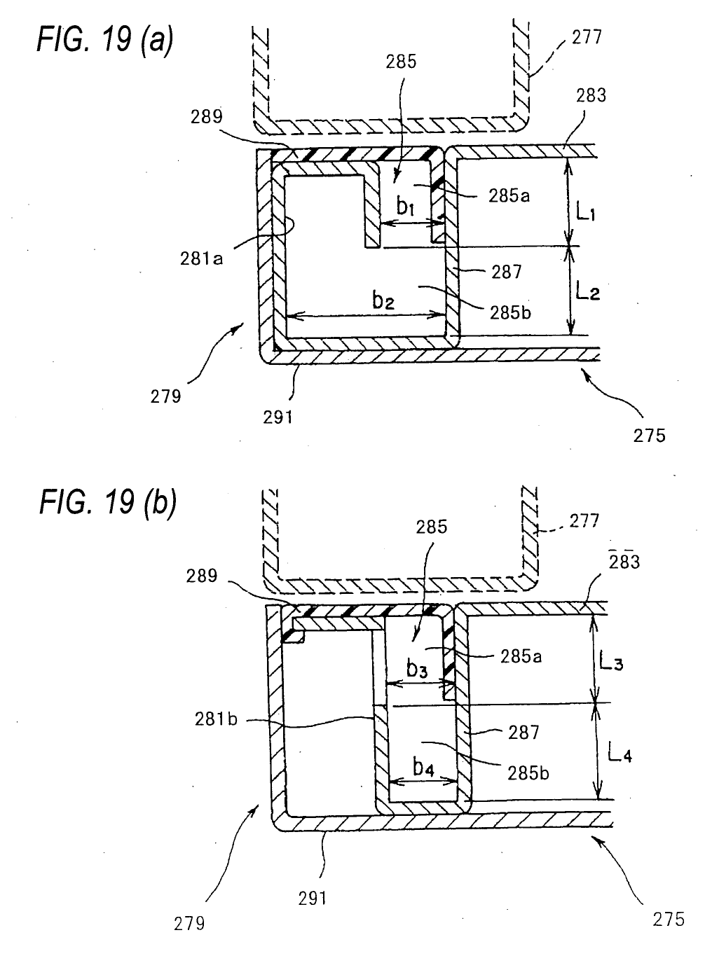

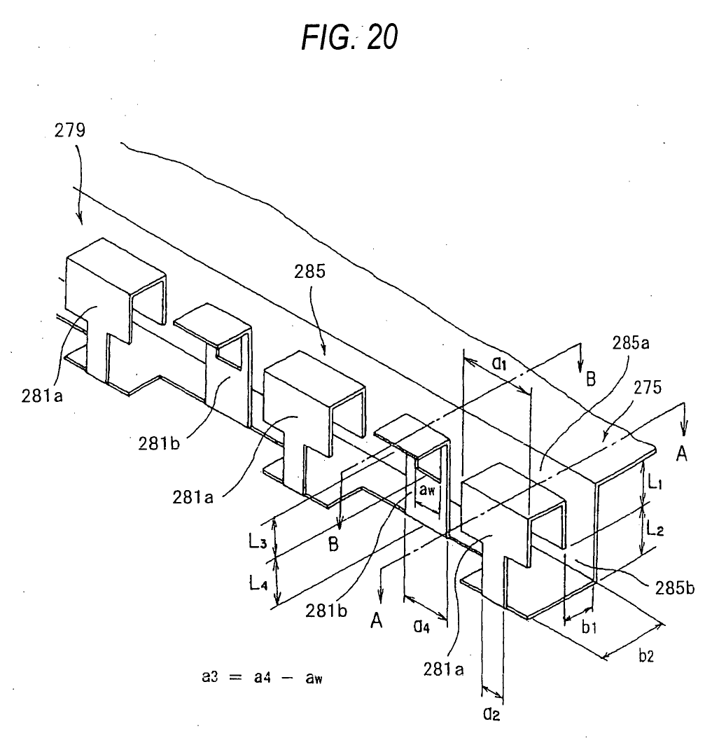

Here, FIG. 19 illustrates a section 19(a) taken along a line A-A of FIG. 18 and a section 19(b) taken along a line B-B of FIG. 18 and FIG. 20 shows a perspective view of the choke. With regard to a shape of the choke 279, the shape is constructed by a constitution substantially similar to that of a choke described in Japanese Patent No. 1504201 although frequencies thereof differ from each other. That is, as shown by FIG. 19(a), a base end side wall face 287 is formed by forming the groove 285 by folding at an end portion of the metal plate 283 forming the opening/closing door 275 and by further folding a front end of the metal plate 283 in a U-like shape, wall faces of an opened portion side groove 285a having a groove width of b1 and a shortcircuit side groove 285b having a groove width of b2 are formed. Further, as shown by FIG. 20, there are formed a plurality of the conductor pieces 281a by constituting lead wire widths by a1, a3 on a side of the opened portion side groove 285a, and constituting lead wire widths by a2, a4 on a side of the shortcircuit side groove 285b.

Further, at the section taken along the line B-B of Fib. 19(b), a plurality of conductor pieces 281b having a shape similar to that of the conductor piece 281a are formed by constituting a groove width by b3 on the side of the opened hole portion side groove 285a and constituting the groove width by b4 on the side of the shortcircuit side groove 285b.

The conductor pieces 281a, 281b are contained alternately in the groove 285, an opened hole end of the groove 285 is covered by a groove cover 289, further, an outer side of the opening/closing door 275 is covered by a door cover 291. According to the choke 279 having the above-described constitution, a ratio K1 of a characteristic impedance of the groove shown by the section A-A is represented by Equation (1).

$$( Equation 1 ) \\ {K}_{1} = \frac{{a}_{1} \cdot {b}_{2} \sqrt{{ɛ}_{eff 1}}}{{a}_{2} \cdot {b}_{3}} \qquad ( 1 )$$

Further, a ratio K2 of a characteristic impedance of the groove shown by the section B-B is represented by Equation (2).

$$( Equation 2 ) \\ {K}_{2} = \frac{{a}_{3} \cdot {b}_{4} \sqrt{{ɛ}_{eff 2}}}{{a}_{4} \cdot {b}_{3}} \qquad ( 2 )$$

Respective values of K1, K2, mentioned above, are respectively set such that depths (L1+L2) and (L3+L4) of the grooves become the same. Further, notations ∈ eff1, ∈eff2 designate effective dielectric constants of the respective groove portions.

Here, a characteristic impedance, a length, a phase constant of the groove opened hole portion side groove are designated by notations ZO1, L1, β1 and a characteristic impedance, a length, a phase constant of the groove shortcircuit portion side groove are designated by notations ZO2, L2, β2. Further, when a distance from an opened hole end to a shortcircuit end of the groove (depth of groove) is designated by notation L (total), L (total)=L1+L2. An impedance Z at the opened hole end of the groove is represented by Equation (3) under the above-described condition.

$$( Equation 3 ) \\ Z = {jZ}_{o 1} \cdot \frac{tan {β}_{1} {L}_{1} + K tan {β}_{2} {L}_{2}}{1 - K tan {β}_{1} {L}_{1} \cdot tan {β}_{2} {L}_{2}} \qquad ( 3 )$$

where K=ZO2/ZO1

According to the embodiment, the characteristic impedances are constituted by ZO2≠ZO1 and therefore, the Equation (3), the value of the ratio K of the characteristic impedances becomes K≠1. In order to make the impedance Z at the opened hole end of the groove infinitive, a denominator of Equation (3) may be nullified and therefore, 1=K tan β1L1·tan β2L2 may be satisfied. Therefore, since the values of K1, K2 can arbitrarily be set by adjusting a1, a2, a3, a4 and b1, b2, b3, b4 and therefore, by pertinently setting K1, K2, the single groove can be provided with a seal effect for two kinds of frequencies of 2.45 GHz and 5.8 GHz.

That is, the value of the characteristic impedance ratio K is determined such that the depth (L3+L4) of the groove for the high frequency wave of 5.8 GHz and the depth (L1+L2) of the groove for the high frequency of 2.45 GHz become the same. For example, based on the characteristic impedance ratio K1 for 2.45 GHz, the depth (L1+L2) of the groove is determined and the value of the characteristic impedance ratio K2 for 5.8 GHz is determined to coincide therewith. For example, when a thickness of the opening/closing door is made to be about 20 mm, by constituting a combination of K1>1, K2<1, there can be constituted the groove for preventing leakage of radio wave effectively operated for two kinds of the high frequency waves of 2.45 GHz and 5.8 GHz.

As described above, according to the constitution of the choke of the embodiment, one or more of the grooves are provided at at least one of portions of the heating chamber main body 277 and the opening/closing door 275 opposed to each other, at least one wall face of the groove is constituted by a group of the conductor pieces continuously aligned at intervals in a longitudinal direction of the groove and in parallel with the wall face of the groove, a lead wire path is constituted by arranging the conductor pieces such that the groove width is periodically changed, and by periodically changing the ratio of the characteristic impedance of the opening portion of the groove to the characteristic impedance of the shortciruict end portion of the groove by changing at least one of the dielectric constant, the lead wire path width, the groove width in the groove, the high frequency waves having the two different frequencies can simultaneously be shielded.

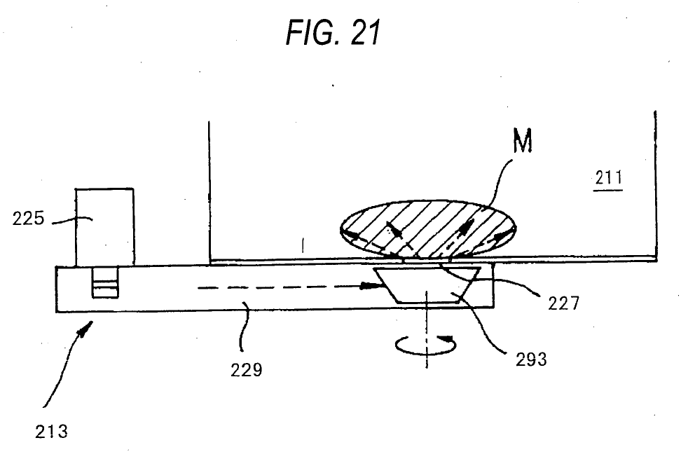

According to the constitution of the high frequency heating apparatus explained above, as shown by an outline section of a portion of the high frequency heating apparatus in FIG. 21, there may be constructed a constitution in which a stirrer blade 293 for stirring radio wave is provided at a vicinity of the lower side feeding port of the wave guide 229 as needed, and radio wave applied to the heating chamber 211 is forcibly stirred by driving to rotate the stirrer blade 293 to thereby achieve further uniform heating.

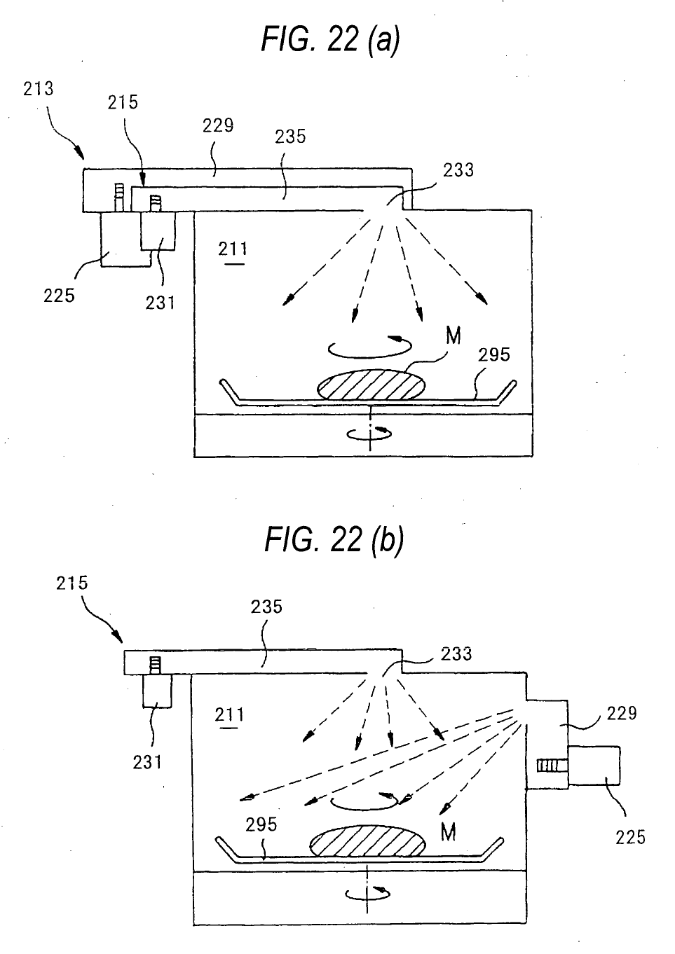

Further, as shown by an outline sectional view of the high frequency heating apparatus in FIG. 22, there may be constructed a constitution in which a turn table 295 axially supported rotatably by the bottom face of the heating chamber 211 to achieve uniform heating. In this case, there may be constructed a constitution in which the first high frequency generating portion 213 is arranged on the upper side of the heating chamber 211 along with the second high frequency generating portion 215 and the high frequency wave is supplied into the heating chamber 211 from a vicinity of the upper side feeding port 233 of the second high frequency generating portion 215 (refer to FIG. 22(a)), further, there may be constructed a constitution in which the first high frequency generating portion 213 is provided at the side face of the heating chamber 11 and the high frequency is supplied into the heating chamber 211 from the side face (refer to FIG. 22(b)).

Next, operation of the high frequency heating apparatus 2100 according to the invention will be explained.

When the heated object M is heated to process by using the high frequency heating apparatus 2100 of the invention, the heating chamber 211 is individually or simultaneously supplied with at least either one of the high frequency wave of 2.45 GHz from the first high frequency generating portion 213 and the high frequency wave of 5.8 GHz from the second high frequency generating portion 215.

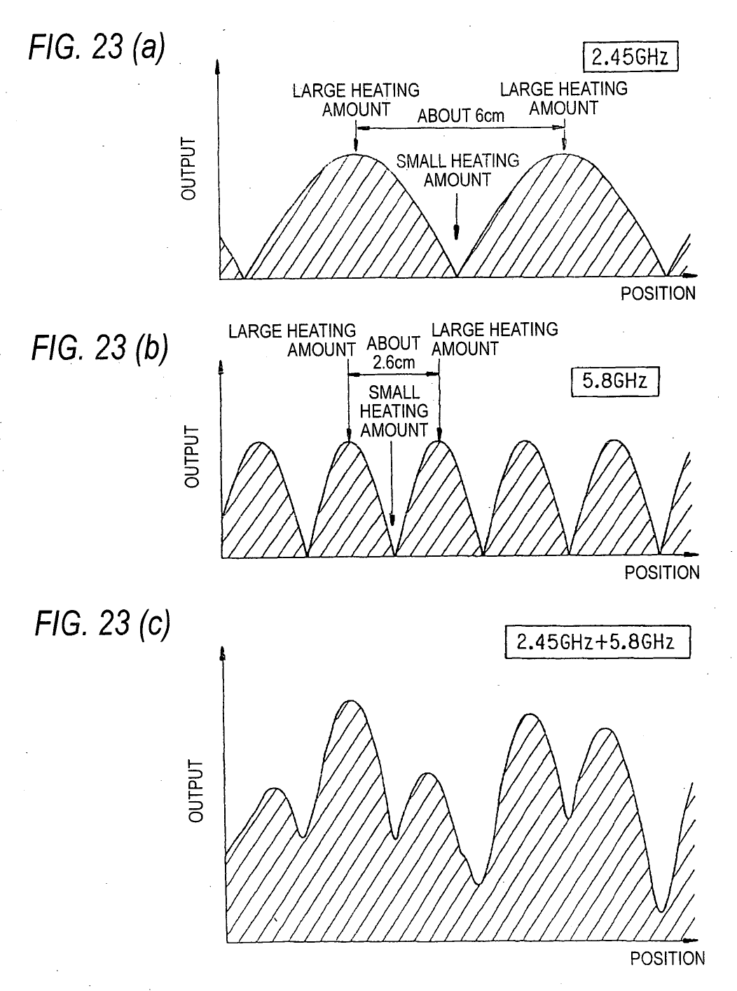

FIG. 23 shows a state of a standing wave at a certain moment appeared in the heating chamber 211 as an example. FIG. 23(a) shows the high frequency wave of 2.45 GHz, FIG. 23(b) shows the high frequency wave of 5.8 GHz, and FIG. 23(c) shows a synthesized wave of the high frequency waves of 2.45 GHz and 5.45 GHz.

In the case of the high frequency wave of 2.45 GHz shown in FIG. 23(a), an interval of portions of antinodes of an electric field at which the heating amount is increased (interval of heating spots) becomes about 6 cm, and for the heated object M having a length of, for example, 30 cm, portions of antinodes of a standing wave can be included by only about 5 points on a straight line. Therefore, an irregularity in heating is liable to be brought about in the heated object M by producing a significant difference between temperature elevating characteristics at a position of the heating spots and a position other than the heating spot.

On the other hand, in the case of the high frequency wave of 5.8 GHz shown in FIG. 23(b), the interval between the heating spots becomes about 2.6 cm and according to the above-described length, heating spots of 10 points or more can be included in the heated object M on a straight line. Therefore, the heated object M is uniformly heated and an irregularity in heating by the location of the heated object M is difficult to be brought about.

However, according to the high frequency wave of 5.8 GHz, an absorption depth for the heated object M tends to be shallowed, and whereas the absorption depth of the high frequency wave of 2.45 GHz is about 5 through 7 cm from the surface of the heated object M, according to the high frequency wave of 5.8 GHz, the absorption depth is shallowed to about 2 through 3 cm from the surface. Therefore, when the heated object M is heated by using only the high frequency wave of 5.8 GHz, although the high frequency wave of 5.8 GHz will do when the heated object M is thin-walled, when the heated object M is thick-walled, a temperature difference between the inner portion and the surface of the heated object M is increased and an irregularity in heating is liable to be brought about.

Hence, as shown by FIG. 23(c), by simultaneously supplying the high frequency wave of 2.45 GHz and the high frequency wave of 5.8 GHz, even when the heated object M is thick-walled, uniform heating can be realized by restraining an irregularity in heating to be small. That is, when the high frequency wave of 2.45 GHz and the high frequency wave of 5.8 GHz are superposed, a heating effect is achieved by increasing a bias even at a portion of a valley of a standing wave at which the heating amount is reduced, thereby, uniform formation of the heat effect of the high frequency wave is achieved and uniform heating without depending on the location or the thickness of the heated object M can be realized.

The characteristics of the respective high frequency waves and differences of the heating effects thereby are summarized and shown in Table 1.

TABLE 1

| | | 2.45 GHz | 5.8 GHz | 2.45 GHz + 5.8 GHz |
|---|---|---|---|---|
| heating distribution | surface | Good | Excellent | Excellent |
| characteristic of heated | inner | Excellent | Good | Excellent |
| object | portion | | | |

| | | | |
|---|---|---|---|
| radio wave invasion depth | 5 through 7 cm | 2 through 3 cm | 2 through 7 cm |
| | from surface | from surface | from surface |
| interval of heating point | about 6 cm | about 2.6 cm | about 2.6 cm |

With regard to the heating distribution characteristic of the heated object M, whereas the high frequency of 5.8 GHz can preferably be utilized in heating pizza, sliced meat product or the like in a large surface area and an irregularity in heating can be restrained from being brought about, in the case of the high frequency of 2.45 GHz, an irregularity in heating is liable to be brought about since the heating points are few. However, by combining the high frequency wave of 2.45 GHz with the high frequency wave of 5.8 GHz, uniform heating can be realized even when a thin-walled product. Further, the high frequency wave of 2.45 GHz is more advantageous for the thick-walled heated object, in the case of the high frequency wave of 5.8 GHz, heat does not permeate to the inner portion of the heated object to constitute heating by heat conduction from the surface and a heating time period tends to be prolonged, however, by combining the high frequency wave of 5.8 GHz with the high frequency wave of 2.45 GHz, also the inner portion of the heated object can swiftly be heated.

Further, even when the high frequency wave of 2.45 GHz and the high frequency wave of 5.8 GHz are alternately switched to supply, substantially the similar effect can be achieved.

As described above, by using the high frequencies having different frequencies and adjusting a distribution of respective powers, various modes of standing wave distributions can be formed and heating having a small irregularity in heating, further, a local heating processing can be realized.

Next, a ninth embodiment of the high frequency heating apparatus according to the invention will be explained.

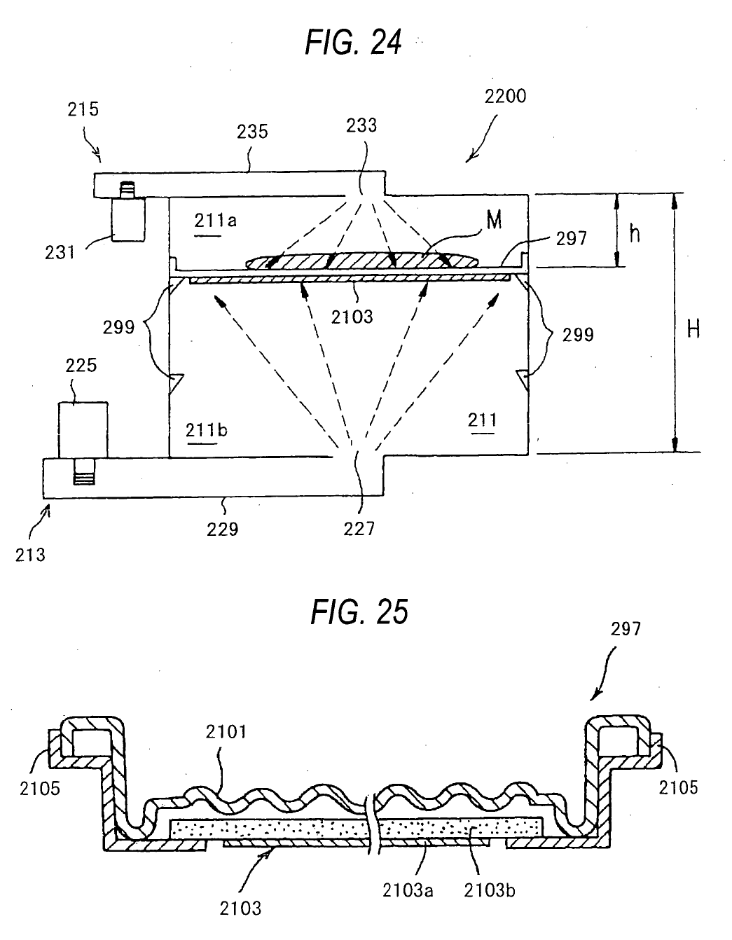

FIG. 24 shows a conceptual sectional constitution view of the high frequency heating apparatus of the embodiment. Further, members having functions the same as those of the constitution of the eighth embodiment, mentioned above, are attached with the same notations to thereby omit the explanation.

As shown by FIG. 24, the high frequency heating apparatus 2200 of the embodiment is constructed by a constitution in which the high frequency wave of 2.45 GHz from the first high frequency generating portion 213 is supplied from the lower side of the heating chamber 211 and the high frequency wave of 5.8 GHz from the second high frequency generating portion 215 is supplied from the upper side of the heating chamber 211, and the partition plate 297 for dividing upward and downward the space of the heating chamber 211 is provided at a position of a distance h from the upper face of the heating chamber 211 relative to a total height H of the heating chamber 211.

The partition plate 297 is made to be attachable and detachable to and from the heating chamber 211 easily at a plurality of height positions, and is attached thereto by being supported by a locking portion 299 formed at a wall face of the heating chamber 211. As is shown by a sectional view of the partition plate in FIG. 25, the partition plate 297 includes a metal plate 2101 constituting a face of mounting the heated object, a high frequency heat generating member 2103 arranged to be opposed to or brought into contact with the metal plate 2101, and a fixing member 2105 for fixing the high frequency heat generating member 2103 to the metal plate 2101 and engaged with the locking portion 299 on the side of the heating chamber 211.

The metal plate 2101 comprises an aluminum-plated steel plate and is provided with recesses and projections in a wavy shape at a surface thereof by forming the recesses and projections by constituting the metal plate 2101 per se by a wavy shape or forming projected portions on the metal plate 2101. A surface side face of the aluminum-plate steel plate is subjected to fluorine coating having a high anticontamination effect and a rear side face thereof is subjected to black heat resistant coating having a high heat absorbing effect.

The high frequency heat generating member 2103 is formed by bringing a high frequency heat generating film 2103a comprising a nitride and a boride generating heat by absorbing the high frequency wave into close contact with a base member 2103b. A material comprising a ceramic material or a heat resistant resin material and having a high heat storing effect is preferably used for the base member 2103.

The fixing members 2105 comprise insulating members provided on the both sides along a direction of inserting the partition plate 297 to the heating chamber 211 and by forming a gap between the fixing member 2105 and the heating chamber 211, generation of spark is prevented in high frequency heating.

Further, by constituting the metal plate 2101 by the wavy shape, a distance between the high frequency absorbing film 2103a and the metal plate 2101 is prolonged, thereby, an electric field intensity on the high frequency absorbing film 2103a is increased to thereby achieve also an effect of increasing a heat generating amount on the high frequency absorbing film 2103a. Further, as the high frequency heat generating member 2103, other than the constitution of providing the high frequency heat generating film 2103a on the rear face, the high frequency heat generating member per se may be formed by a ceramic generating heat by the high frequency wave.

Although as the metal plate 2101, the aluminum-plated steel plate made of metal is used, a base member of a ceramic material provided with a layer of reflecting the high frequency wave by metal plating, metal vapor deposition or the like can also be utilized so far as a surface thereof reflects the high frequency wave, further, stainless steel, aluminum and an aluminum alloy, various steel plates of zinc-plated steel plate, aluminum zinc alloy-plated steel plate, copper-plated steel plate and the like and a clad material or the like can also be used. Further, although a nitride or a boride is used as the high frequency absorbing film 281, a metal oxide of tin oxide, indium oxide or the like as well as composite oxide or the like can also be used.

According to the high frequency heating apparatus 2200 having the above-described constitution, the heating chamber 211 is divided into two spaces of an upper side space and a lower side space and a desired heating processing can be carried out at the respective spaces.

That is, according to the high frequency heating apparatus 2200, an upper side space 211a of the heating chamber 211 is supplied with the high frequency wave of 5.8 GHz from the second high frequency generating portion 215, further, a lower side space 211b of the heating chamber 211 is supplied with the high frequency wave of 2.45 GHz from the first high frequency generating portion 213. The heated object M mounted on the partition plate 297 of the upper side space 211a is heated by the high frequency wave of 5.8 GHz supplied from the upper side and also heated by heat generated by the high frequency heat generating member 2103 by the high frequency wave of 2.45 GHz supplied from the lower side. In this case, so-to-speak grill cooking is carried out at the upper side space 211a. On the other hand, at the lower side space 211b, by mounting the heated object M on the bottom face of the heating chamber 211, frequency heating of 2.45 GHz is carried out.

Further, there may be constructed a constitution in which the high frequency heat generating member 2103 is not provided to the partition plate 297. In that case, in the upper side space, the heated object M can be heated to process mainly by the high frequency heating from the upper side by restricting heating by the high frequency from the lower side.

Further, the high frequency wave supplied from the upper side may be constituted by the frequency of 5.8 GHz and the high frequency wave supplied from the lower side may be constituted by the frequency of 2.45 GHz.

According to the above-described constitution, other than supplying the high frequency waves of the respective frequencies of the common heating chamber 11, by respectively forming the individual heating spaces 211a, 211b, heating by the high frequency waves of the respective frequencies can be carried out individually at the respective spaces 211a, 211b. Thereby, heating energy more than necessary is not supplied by preparing a space more than necessary relative to the size of the heated object M and by setting the space to an arbitrary size, wasteless high frequency heating can be carried out.

Further, a fixed type partition structure may be constituted in place of the attachable and detachable partition plate 297 to thereby construct a constitution of forming the individual heating spaces by the high frequency waves of the respective frequencies. In this case, operation of attaching and detaching the partition plate 297 is not needed and heating operation can be simplified.

Here, an explanation will be given of a constitution example of simplifying the constitution of the high frequency driving portion 217 of the high frequency heating apparatus 2100.

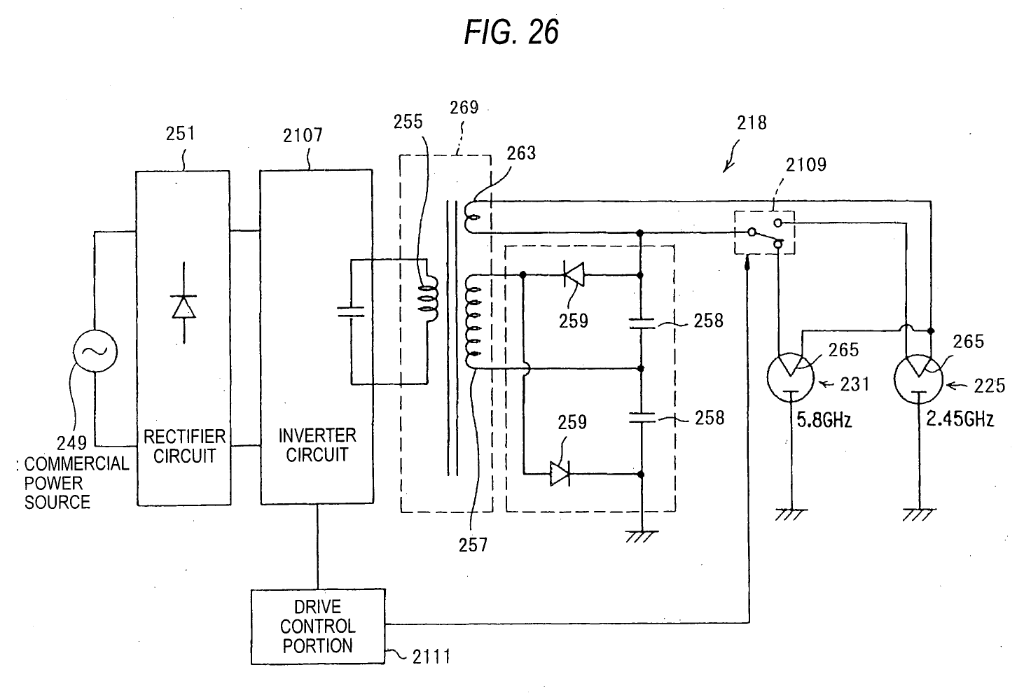

Although as shown by FIG. 17, the high frequency driving portion 217 is respectively provided with the inverter circuits for individually driving the respective magnetrons 225, 231, as shown by other constitution example of the high frequency driving portion shown in FIG. 26, there may be constructed a constitution of driving the high frequency driving portion by a single inverter circuit.

That is, there is constructed a constitution having the drive control portion 2111 connected to an inverter circuit 2107 and controlling to switch a change over switch 2109 for switching the magnetrons to be driven and enabling to output the high frequency wave of 2.8 GHz and the high frequency wave of 2.45 GHz by switching to control the change over switch 2109 at a pertinent timing based on the signal from the control portion 219 (refer to FIG. 16).

According to a high frequency driving portion 218 having the above-described constitution, two different kinds of the magnetrons 225, 231 can be driven by the single inverter circuit and therefore, the circuit constitution of the high frequency driving portion 218 can considerably be simplified and a necessary installing space is reduced, which can contribute to small-sized and light-weighted formation of the apparatus.

An explanation will be given of controlling to drive the first high frequency generating portion 213 and the second high frequency generating portion 215 as follows.

The control portion 219 (refer to FIG. 16) outputs a signal of distributing a power from the power source to the magnetron 225 for 2.45 GHz constituting the first high frequency generating portion 213 and the magnetron 231 for 5.8 GHz constituting the second high frequency generating portion 215 to the drive control portion 273 (refer to FIG. 17) and the drive control portion 273 distributes to feed electricity to the first inverter circuit 237 and the second inverter circuit 267 by receiving the distribution signal.

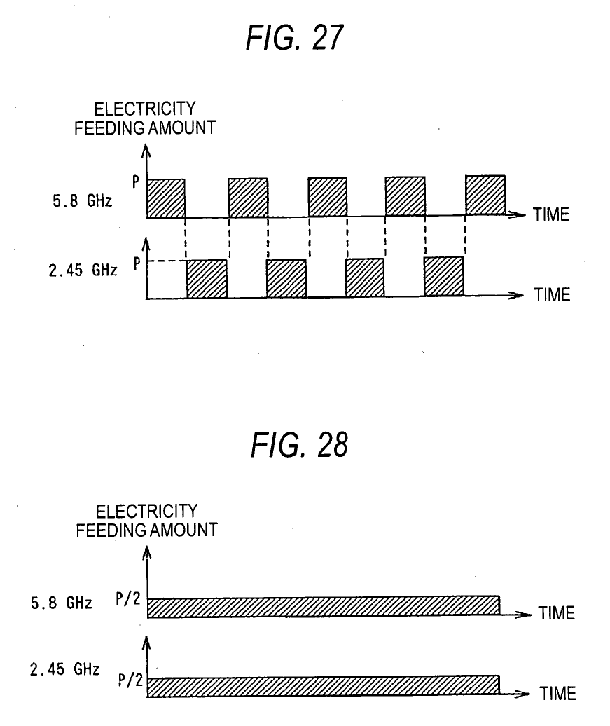

An explanation will be given of electricity feeding patterns to the first high frequency generating portion 213, the second high frequency generating portion 215 in this case in reference to FIG. 27 through FIG. 30.

FIG. 27 is a pattern of alternately outputting the high frequency waves of 5.8 GHz and 2.45 GHz. According to the electricity feeding pattern, the high frequency waves are outputted alternately, both of the high frequency waves are not outputted simultaneously and therefore, outputs of the respective high frequency waves can be applied to output up to a rated power of the high frequency heating apparatus. Therefore, the heated object can efficiently be heated by making the outputs of the respective high frequency generating portions by a maximum output.

FIG. 13 is a pattern of simultaneously outputting the high frequency waves of 5.8 GHz and 2.45 GHz. The outputs in this case are controlled such that a total power of the both high frequency waves does not exceed the rated power of the high frequency heating apparatus. In the drawing, there is shown a state of setting the outputs of the both high frequency waves respectively to P/2 when the rated power is designated by notation P. A rate of power distribution can be set to an arbitrary rate, otherwise, further, for example, the rate of the power distribution can be changed after elapse of a predetermined time period.

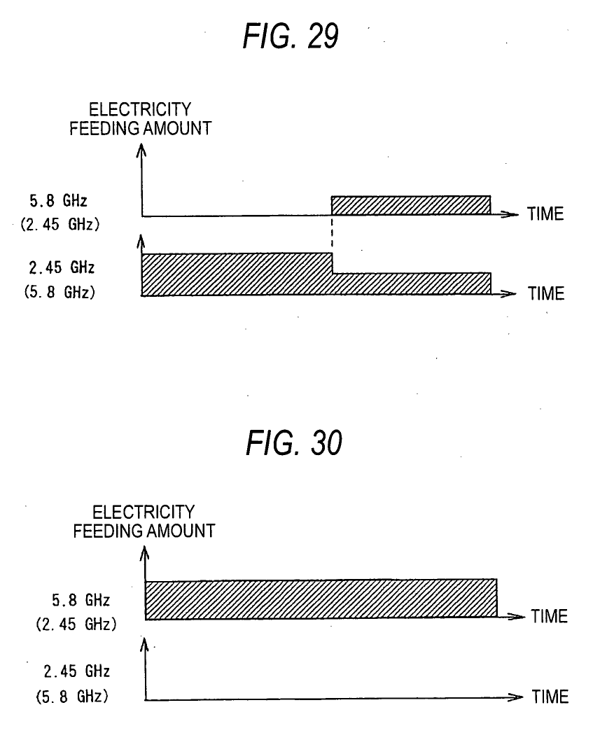

FIG. 29 shows a pattern of precedingly outputting the high frequency of 2.45 GHz and succeedingly outputting the high frequency wave of 5.8 GHz. According to the pattern, at an initial stage of heating at which a temperature of the heated object is low, the temperature of the heated object is elevated in one motion by supplying the high frequency wave of 2.45 GHz having a comparatively high heating effect, further, the high frequency of 5.8 GHz is supplied after elapse of a predetermined time period or after reaching a predetermined temperature, thereby, uniform formation of the heating temperature is achieved and the uniform heating state having a small temperature distribution can be constituted. Further, there may be constituted a pattern of precedingly outputting the high frequency wave of 5.8 GHz and succeedingly outputting the high frequency wave of 2.45 GHz contrary thereto. In this case, the pattern is preferable for cooking of strongly heating the heated object at a later half of heating. Further, in the case of simultaneously outputting the respective high frequency waves at the later half of heating, there may be constituted a pattern of alternately outputting the respective high frequency waves as shown by FIG. 27. In that case, the respective outputs can be applied up to the maximum outputs.

FIG. 30 shows a pattern of outputting commonly the high frequency wave of 5.8 GHz. The pattern is preferable particularly for heating a thin-walled heated object and the heated object can be finished in a state of having a small temperature distribution. Further, there may be constituted a pattern of outputting only the high frequency wave of 2.45 GHz. In this case, the high frequency heating similar to that of the background art can be carried out.

Although the invention has been explained in details in reference to the specific embodiments, it is apparent for a skilled person that the invention can variously be changed or modified without deviating from the spirit and the range of the invention.

The application is based on Japanese Patent Application No. 2003-121876 filed on Apr. 25, 2003, Japanese Patent Application No. 2003-130370 filed on May 8, 2003, Japanese Patent Application No. 2003-131804 filed on May 9, 2003, and a content thereof is incorporated herein by reference.

### INDUSTRIAL APPLICABILITY

According to the high frequency heating apparatus of the invention, the distribution of the heating spots by the microwave can be widened to a wider range of the heating chamber partitioned by the cavity, the microwave is made to impinge on to a wider range portion of the surface of the heated object.

As a result, even in the case of the microwave of 5.8 GHz having a shallow baking depth, the substantial baking depth can be intensified to double by heating the heated object from, for example, both directions opposed to each other, and an irregularity in heating can be prevented from being brought about over entire regions of the surface layer and the inner depth portion of the heated object without mounting the electromagnetic wave stirring means in the heating chamber.

Therefore, excellent heating without a nonuiformity in heating can be realized even for the thick-walled heated object, and simplification of the structure and small-sized formation of the apparatus in accordance therewith, or a reduction in fabricating cost or running cost can be achieved by deleting the electromagnetic stirring means.

Further, according to the high frequency heating apparatus of the invention, the wide range wave guide in the shape of the parallelepiped constituted by including a number of the feeding ports is provided on the rear side of the heating chamber, the high frequency generating portion is provided an immediate vicinity of the wide range wave guide in the shape of the parallelepiped and therefore, the structure of the wave guide is constituted by a structure having the wide width and therefore, a number of feeding ports can be provided and heating can be made to be proximate to uniform heating.

Further, according to the invention, the wide range wave guide in the shape of the parallelepiped is constituted by the size widening substantially over an entire face of the floor portion and a number of feeding ports are provided on the rear side of the floor portion to direct to the side of the floor portion and therefore, there is not brought about the difference in the electric field intensity of the microwave between the center and the corner of the heating chamber and heating can be made to be proximate to uniform heating. Further, since the microwave is irradiated from the floor portion and therefore, the irradiation is proximate to the heated portion and also the heating efficiency is improved.

Further, the constitution of a turn table, a rotational antenna or the like for stirring radio wave may not be provided and therefore, reliability against radio wave spark, radio wave leakage or the like is also promoted.

Further, according to the invention, the wide range wave guide in the shape of the parallelepiped is constituted by the size widening substantially over the entire face of the ceiling and the number of feeding ports are provided on the rear side of the ceiling to direct to the side of the ceiling and therefore, uniform radio wave falls from the single face of the ceiling as in a shower and therefore, further uniform heating can be carried out.

Further, according to the invention, the frequency of the high frequency wave supplied from the high frequency generating portion is 5.8 GHz and therefore, in comparison with a case in which a wave length of the microwave is 2.45 GHz constituting the main current of the background art, the interval of the standing waves is narrowed and heating can be made to be proximate to further uniform heating.

Further, according to the invention, the size of the feeding port is smaller at a vicinity of the high frequency generating portion, the remoter from the high frequency generating portion, the larger the size and therefore, there is not brought about a difference in the electric field intensity of the microwave between the portion proximate to the high frequency generating portion and the portion remote from the high frequency generating portion and heating can be made to be proximate further uniform heating.

Further, according to the high frequency heating apparatus of the invention, there is provided the high frequency heating apparatus for heating to process the heated object by supplying the high frequency from the high frequency generating portion to the heating chamber for containing the heated object, in which the high frequency generating portion is provided with the first high frequency generating portion for generating the high frequency wave having the frequency of 2.45 GHz and the second high frequency generating portion for generating the high frequency wave having the frequency of 5.8 GHz, thereby, two kinds of the high frequency waves of the high frequency wave having the frequency of 2.45 GHz having a high heating effect and the high frequency wave having the frequency of 5.8 GHz the heating distribution of which is uniform can be supplied to the heating chamber, a nonuiformity in heating is restrained from being brought about, and even the thick-walled heated object can be heated to process swiftly and uniformly.

Further, according to the method of controlling the high frequency heating apparatus of the invention, by supplying the high frequency wave having the frequency of 2.45 GHz and the high frequency wave having the frequency of 5.8 GHz to the heating chamber simultaneously or alternately, the high frequency wave of 2.45 GHz having the high heating effect and the high frequency wave of 5.8 GHz the uniform effect of which is high can selectively be supplied and therefore, an efficient heating processing can be carried out by supplying the pertinent high frequency wave in accordance with the shape of the heated object and the object of heating.

1. A high frequency heating apparatus in that a microwave of 5.8 GHZ is irradiated to an object in a heating chamber in order to heat the object;
wherein a plurality of pieces of wave guides having feeding ports for emitting the microwave are mounted to a cavity partitioning the heating chamber.

2. The high frequency heating apparatus according to claim 1, wherein a wall face of the cavity arranged with the feeding port is constituted by upper and lower faces, or the upper face and a side face, or the side face and the lower face of the heating chamber.

3. The high frequency heating apparatus according to claim 1, wherein two pieces of the feeding ports are provided to the upper face of the heating chamber by at least two pieces of the wave guides arranged at an upper wall of the cavity.

4. The high frequency heating apparatus according to claim 3, wherein the at least two pieces of wave guides at the upper wall of the cavity are arranged vertically to direct long sides of cross-sectional faces of the wave guides in an up and down direction.

5. The high frequency heating apparatus according to claim 4, wherein a face heater is arranged at a region of the upper wall of the cavity excluding a region of mounting the wave guides arranged vertically.

6. A high frequency heating apparatus comprising:
a high frequency generating portion; and
a heating chamber constituted by a ceiling, a side wall and a floor portion for heating to process a heated object by applying a high frequency wave from the high frequency generating portion;
wherein a wide range wave guide in a shape of a parallelepiped constituted by including a number of feeding ports is provided on a rear side of the heating chamber, and
the high frequency generating portion is provided at immediate proximity of the wide range wave guide of the shape of the parallelepiped.

7. The high frequency heating apparatus according to claim 6, wherein the wide range wave guide in the shape of the parallelepiped is constituted by a size widened substantially over an entire face of the floor portion and the number of feeding ports are provided on a rear side of the floor portion to direct to a side of the floor portion.

8. The high frequency heating apparatus according to claim 6, wherein the wide range wave guide in the shape of the parallelepiped is constituted by a size widened substantially over an entire face of the ceiling and the number of feeding ports are provided on a rear side of the ceiling to direct to a side of the ceiling.

9. The high frequency heating apparatus according to any one of claims 6 through 8, wherein a frequency of the high frequency wave supplied from the high frequency generating portion is 5.8 GHz.

10. The high frequency heating apparatus according to claim 6, wherein sizes of the number of pieces of feeding ports are smaller at a vicinity of the high frequency generating portion and the remoter from the high frequency generating portion, the larger the sizes.

11. A high frequency heating apparatus for heating an object to be heated, comprising:
a heating chamber for containing the object;
a high frequency generating portion for supplying a high frequency wave to the heating chamber;
wherein the high frequency generating portion includes a first high frequency generating portion for generating the high frequency wave having a frequency of 2.45 GHz and a second high frequency generating portion for generating the high frequency wave having a frequency of 5.8 GHz.

12. The high frequency heating apparatus according to claim 11, further comprising:
a first inverter circuit for supplying a drive power to the first high frequency generating portion;
a second inverter circuit for supplying a drive power to the second high frequency generating portion; and
a drive control portion for simultaneously or alternately driving the first high frequency generating portion and the second high frequency generating portion by the inverter circuits.

13. The high frequency heating apparatus according to claim 11, further comprising:
a single inverter circuit for supplying a drive power to the first high frequency generating portion and the second high frequency generating portion; and
a drive control portion for alternately switching to feed electricity to drive the first high frequency generating portion and the second high frequency generating portion.

14. The high frequency heating apparatus according to claim 11, further including:
an upper side feeding port provided at an upper face of the heating chamber for introducing the high frequency wave into the heating chamber; and
a lower side feeding port provided at a lower face of the heating chamber for introducing the high frequency wave into the heating chamber;
wherein the high frequency wave from the first high frequency generating portion or the second high frequency generating portion is introduced individually from respectives of the upper side feeding port and the lower side feeding port.

15. The high frequency heating apparatus according to claim 14, further comprising:
a partition plate for dividing a space of the heating chamber upward and downward.

16. The high frequency heating apparatus according to claim 15, wherein the partition plate includes a high frequency heat generating member for generating heat by being irradiated with the high frequency wave.

17. The high frequency heating apparatus according to any one of claims 14 through 16, wherein the high frequency wave from the second high frequency generating portion is introduced into the heating chamber from the upper side feeding port of the heating chamber.

18. The high frequency heating apparatus according to claim 11, wherein the heating chamber includes a heating chamber main body having an opening portion, and an opening/closing door for openably and closably covering the opening portion, and at least one of portions of the heating chamber main body and the opening/closing door opposed to each other is formed with a choke for preventing leakage of a radio wave; and
wherein the choke shields the high frequency waves respectively from the first high frequency generating portion and the second high frequency generating portion.

19. A method of controlling a high frequency heating apparatus which is a method of controlling a high frequency heating apparatus for heating to process a heated object by supplying a high frequency wave from a high frequency generating portion to a heating chamber containing the heated object;
wherein the high frequency wave having a frequency of 2.45 GHz and the high frequency wave having a frequency of 5.8 GHz are simultaneously or alternately supplied from the high frequency generating portion to the heating chamber.

20. The method of controlling a high frequency heating apparatus according to claim 19, wherein the high frequency wave having either one of the respective frequencies is outputted at an initial stage of heating and the high frequency wave having other of the respective frequencies is started to output after elapse of a predetermined time period or after reaching a predetermined temperature from starting to heat the heated object.

21. The method of controlling a high frequency heating apparatus according to claim 19, wherein when the high frequency waves having the respective frequencies are simultaneously outputted, an output of at least either one of the respective high frequency waves is restricted such that a total of a drive power for outputting the high frequency waves does not exceed a rated power of the high frequency heating apparatus.
